(19) United States
(12) Patent Application Publication
(10) Pub. No.: US 2015/0142532 A1
(43) Pub. Date: May 21, 2015

(54) METHOD AND SYSTEM TO ASSESS, DIAGNOSE, AND OPTIMIZE LEADERSHIP AND OTHER PERFORMANCE SKILL DEVELOPMENT

(71) Applicant: Tom Reynolds, Wilson, WY (US)

(72) Inventor: Tom Reynolds, Wilson, WY (US)

(21) Appl. No.: 14/606,450

(22) Filed: Jan. 27, 2015

Related U.S. Application Data
(63) Continuation-in-part of application No. 14/052,677, filed on Oct. 11, 2013.
Application No. 14/052,677 is a continuation of application No. 13/663,407, filed on Oct. 29, 2012, now abandoned.
Application No. 13/663,407 is a division of application No. 11/925,663, filed on Oct. 26, 2007, now Pat. No. 8,301,482.
Application No. 11/925,663 is a continuation-in-part of application No. 10/927,222, filed on Aug. 25, 2004, now Pat. No. 7,769,626.
(60) Provisional application No. 60/497,882, filed on Aug. 25, 2003.

(51) Int. Cl. G06Q 10/06

(52) U.S. Cl. CPC G06Q 10/06398
USPC 705/7.42

(57) ABSTRACT

A method and system of assessing, diagnosing, and optimizing leadership and other performance skills of an individual within an organization is realized through ratings of various leadership and/or other performance skills within a tired dimensions and sub-dimensions framework by raters of various constituencies within the organization. The ratings may be based on a quantitative score for each dimensions and sub-dimensions as well as a equity on-the-margin qualitative evaluation of the rated score. A developmental recommendation follows from the analysis identifying key areas of improvement needs for the leadership or other performance skills. Further analysis may be conducted with respect to comparisons and identifying discrepancies between the ratings by groups of the constituencies such as the self, superordinates, peers, and subordinates of the individual. The individual may also be assessed relative to norms by organization types, organizational roles, and positions within the organization.

The present application is a continuation-in-part (CIP) application of U.S. patent application Ser. No. 14/052,677, filed Oct. 11, 2013, which is a continuation application of U.S. patent application Ser. No. 13/663,407, filed Oct. 29, 2012, which is a divisional application of U.S. patent application Ser. No. 11/925,663 now U.S. Pat. No. 8,301,482, filed Oct. 26, 2007, which is a CIP application of U.S. patent application Ser. No. 10/927,222 now U.S. Pat. No. 7,769,626, filed Aug. 25, 2004, which claims the benefits of and priority, under 35 U.S.C. §119(e), to U.S. Provisional Application Ser. No. 60/497,882, filed Aug. 25, 2003; each of the above-identified applications being fully incorporated herein by reference.

### BACKGROUND

1. Field of the Invention

This invention relates generally to performance assessment and specifically to systems and methods for providing specific diagnostics to and directing the development and optimization of leadership and other performance skills and traits.

2. Discussion of the Background

Leadership has been described as a process of social influence in which a person can enlist the aid and support others in accomplishing a common task. In various instances, leadership may involve guiding, directing, and organizing a group of people in achieving a common goal. Within a hierarchical or ad hoc organization, effective leadership is often a binding or driving force in the pursuit and completion of tasks or goals of the organization.

As such, effective leadership within an organization is the driving force of business success. The direct outputs of this linchpin to business success are strategy development, tactical implementation planning and execution, and the development and optimally leveraging the skill sets of the business's current and potential employees.

Accordingly, the assessment and diagnostic of an individual (e.g., an employee) is vital to an organization in pursuing the goals of the organization. Further, a systematic and practical methodology for directing an improvement process aids in building and enhancing the individual's leadership skills and attributes and, as an extension, the human resource assets of the organization.

There are multiple positive applications that can benefit from a comprehensive methodology for assessing and diagnosing the leadership skills for the purpose of directing the improvement process for an individual within an organization, including (1) periodically reviewing the individual to evaluate his or her progress, (2) comparing individuals to leadership norms of both the area and position of the individual within the organization and level of experience of the individual, (3) developing formal counseling agendas to facilitate improvement of the individual, (4) recognizing, within the organization, individuals that are not qualified to become leaders and individuals that are talented and should be fast-tracked, (5) optimizing teams within the organization to leverage skill sets of individual members of the team, and (6) providing a framework to be used to determine which individuals of the organization should be promoted.

Accordingly, there is a need for a comprehensive and efficient process that addresses the broad range of the foregoing leadership assessment application areas. Such process would also present a significant business asset leading to competitive advantage to an organization.

In addition, it would be beneficial to an organization for an assessment and diagnostic process on the generalized performance of an individual. For example, many individuals, including leaders and non-leaders, make up part of the team. While leadership traits and skills of the leader may be an important driving force to the success of the team and the organization by extension, the performance, and the ability to perform, of each members of the team also represents important contributions to the success of the team and the organization.

Accordingly, there is a further need for a comprehensive and efficient process for performance assessment and diagnostics.

### SUMMARY OF THE INVENTION

The present disclosure can provide a number of advantages depending on the particular aspect, embodiment, and/or configuration. These and other advantages will be apparent from the disclosure. Additional features and advantages may be learned by the practice of the invention.

To achieve these and other advantages, as embodied and broadly described, a method for assessing and tracking leadership skills of an individual of an organization includes performing following steps (a)-(e): (a) the step of obtaining one or more evaluation data related to one or more ratings of the individual, each of the rating corresponding to a dimension of a predetermined set of dimensions defining key leadership traits or skills for the individual, wherein each evaluation data is obtained from a relevant constituency of the organization, and wherein one of the evaluation data is obtained from the individual; (b) the step of obtaining a response from the relevant constituency or the individual, the response includes, for the each of the corresponding evaluation data, each of (i) and (ii): (i) a first reason for the rating not being one step more positive, when the rating is not a highest available rating; and (ii) a second reason for the rating not being one step more negative, when the rating is not a lowest available rating; (c) the step of storing the evaluation data, including the response; (d) the step of evaluating a first portion of a summary of the evaluation data, including the response, of all of the relevant constituencies and the individual, across the predetermined set of dimensions, wherein the first portion includes an aggregate rating of the individual for the each of the corresponding dimension and a comparison of the aggregate rating with the rating obtained from the individual for the each of the corresponding dimension; and (e) the step of evaluating a second portion of the summary, wherein the second portion includes an identification of one or more areas of growth potentials corresponding to one or more selected grouped dimensions of the predetermined set of dimensions, wherein the identification of the areas of the growth potentials includes a summary of each dimension with respect to either (i) a lowest rating in each of the selected grouped dimensions or (ii) identified by the relevant constituency or the individual, for each of the relevant constituency and the individual.

In another embodiment, a method for assessing and tracking leadership skills of an individual of an organization includes performing following steps (a)-(e): (a) the step of obtaining, by computational equipment, one or more evaluation data related to one or more ratings of the individual, each rating corresponding to a dimension of a predetermined set of dimensions of leadership traits or skills for the individual, wherein each evaluation data is obtained from a relevant constituency of the organization, wherein one of the evaluation data is obtained from the individual, and wherein the step of (a) includes (a-i) and (a-ii): (a-i) the step of displaying, through the computational equipment, to the relevant constituency or the individual a survey containing a series of question related to the predetermined set of dimensions; and (a-ii) the step of receiving, through the computational equipment, from the relevant constituency or the individual a response to the survey that includes the rating, wherein the rating includes a numerical assessment of the individual, for a dimension of the predetermined set of dimensions, based a scale; (b) the step of receiving, through the computational equipment, a response from the relevant constituency or the individual, the response includes, for the each of the corresponding evaluation data, each of (i) and (ii): (i) a first reason for the rating not being one step more positive, when the rating is not a highest available rating; and (ii) a second reason for the rating not being one step more negative, when the rating is not a lowest available rating; (c) the step of storing, using the computational equipment, the evaluation data, including the response; (d) the step of evaluating, using the computational equipment, a first portion of a summary of the evaluation data, including the response, of all of the relevant constituencies and the individual, across the predetermined set of dimensions, wherein the first portion includes an aggregate rating of the individual for the each of the corresponding dimension and a comparison of the aggregate rating with the rating obtained from the individual for the each of the corresponding dimension; and (e) the step of evaluating, using the computational equipment a second portion of the summary, wherein the second portion includes an identification of one or more areas of growth potentials corresponding to one or more selected grouped dimensions of the predetermined set of dimensions, wherein the identification of the areas of the growth potentials includes a summary of each dimension with respect to either (i) a lowest rating in each of the selected grouped dimensions or (ii) identified by the relevant constituency or the individual, for each of the relevant constituency and the individual.

In another embodiment, a method for assessing and tracking leadership skills of an individual of an organization includes performing following steps (a)-(e): (a) the step of receiving an initial order for an assessment or tracking of the leadership skills of the individual; (b) the step of obtaining one or more evaluation data related to one or more ratings of the individual, each rating corresponding to a dimension of a predetermined set of dimensions of leadership traits or skills for the individual, wherein each evaluation data is obtained from a relevant constituency of the organization, and wherein one of the evaluation data is obtained from the individual; (c) the step of obtaining a response from the relevant constituency or the individual, the response includes, for the each of the corresponding evaluation data, each of (i) and (ii): (i) a first reason for the rating not being one step more positive, when the rating is not a highest available rating; and (ii) a second reason for the rating not being one step more negative, when the rating is not a lowest available rating; (d) the step of storing the evaluation data, including the response; (e) the step of evaluating a first portion of a summary of the evaluation data, including the response, of all of the relevant constituencies and the individual, across the predetermined set of dimensions, wherein the first portion includes an aggregate rating of the individual for the each of the corresponding dimension and a comparison of the aggregate rating with the rating obtained from the individual for the each of the corresponding dimension; (f) the step of evaluating a second portion of the summary, wherein the second portion includes an identification of one or more areas of growth potentials corresponding to one or more selected grouped dimensions of the predetermined set of dimensions, wherein the identification of the areas of the growth potentials includes a summary of each dimension with respect to either (i) a lowest rating in each of the selected grouped dimensions or (ii) identified by the relevant constituency or the individual, for each of the relevant constituency and the individual; and (g) the step of preparing an assessment report for the individual based on the evaluation data, the assessment report including a summary of the average rating for the each of the corresponding dimension, the comparison of the aggregate rating with the rating obtained from the individual for the each of the corresponding dimension, a comparison of the rating obtained from one or more groups of the relevant constituency with each other and with the individual, a summary of comments for the each of the corresponding dimension, and one or more recommendation priorities corresponding to one or more of the dimensions.

In another embodiment, a method for assessing and tracking performance of an individual of an organization, includes performing following steps (a)-(f): (a) the step of determining a set of dimensions defining key traits and skills related to the performance being assessed and tracked; (b) the step of obtaining one or more evaluation data related to one or more ratings of the individual, each of the rating corresponding to a dimension of the set of dimensions for the individual, wherein each evaluation data is obtained from a relevant constituency of the organization, and wherein one of the evaluation data is obtained from the individual; (c) the step of obtaining a response from the relevant constituency or the individual, the response includes, for the each of the corresponding evaluation data, each of (i) and (ii): (i) a first reason for the rating not being one step more positive, when the rating is not a highest available rating; and (ii) a second reason for the rating not being one step more negative, when the rating is not a lowest available rating; (d) the step of storing the evaluation data, including the response; (e) the step of evaluating a first portion of a summary of the evaluation data, including the response, of all of the relevant constituencies and the individual, across the set of dimensions, wherein the first portion includes an aggregate rating of the individual for the each of the corresponding dimension and a comparison of the aggregate rating with the rating obtained from the individual for the each of the corresponding dimension; and (f) the step of evaluating a second portion of the summary, wherein the second portion includes an identification of one or more areas of growth potentials corresponding to one or more selected grouped dimensions of the set of dimensions, wherein the identification of the areas of the growth potentials includes a summary of each dimension with respect to either (i) a lowest rating in each of the selected grouped dimensions or (ii) identified by the relevant constituency or the individual, for each of the relevant constituency and the individual.

Other aspects and distinct advantages of the invention will become apparent upon formal specification.

The present invention accordingly comprises the various steps and the relation of one or more of the steps with respect to each of the others, and the system embodies features of construction, combinations of elements, and the arrangement or the component facets which are adapted to effect such steps, as is exemplified in the following detailed disclosure, and the scope of the invention will be indicated in the claims.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module,” as used herein, refers to any known or later developed hardware, software, firmware, artificial intelligence, fuzzy logic, or combination of hardware and software that is capable of performing the functionality associated with that element.

The terms “determine,” “calculate,” and “compute,” and variations thereof, as used herein, are used interchangeably and include any type of methodology, process, mathematical operation or technique.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible, utilizing, alone or in combination, one or more of the features set forth above or described in detail below.

### BRIEF DESCRIPTION OF THE DRAWINGS

FIG. 1 illustrates a key framework in view of leadership framing contextual variables and personal traits and skills pivotal to an organization according to an embodiment;

FIG. 2 illustrates a schema of personal leadership traits and skills as leadership dimensions and sub-dimensions grouped by tiers of leadership competencies according to an embodiment;

FIG. 3 illustrates an exemplary leadership assessment rating scheme according to an embodiment

FIG. 4 illustrates an exemplary rating to leadership assessment rating scheme according to an embodiment;

FIG. 5 illustrates an exemplary developmental recommendation based on ratings to leadership assessment rating scheme according to an embodiment;

FIG. 6 illustrates an exemplary summary based on ratings to leadership assessment rating scheme according to an embodiment;

FIGS. 7A-7C illustrate exemplary descriptive summaries based on ratings to leadership assessment rating scheme according to an embodiment;

FIG. 8 illustrates an exemplary relational diagram rating differences among rater groups for ratings to leadership assessment rating scheme according to an embodiment;

FIGS. 9A-D illustrate exemplary evaluation charts of rating differences among rater groups for ratings to leadership assessment rating scheme according to an embodiment; and

FIG. 10 illustrates a systems diagram of a performance assessment system and related systems according to an embodiment.

### DETAILED DESCRIPTION

Embodiments herein presented are not exhaustive, and further embodiments may be now known or later derived by one skilled in the art.

Functional units described in this specification and figures may be labeled as modules, or outputs in order to more particularly emphasize their structural features. A module and/or output may be implemented as hardware, e.g., comprising circuits, gate arrays, off-the-shelf semiconductors such as logic chips, transistors, or other discrete components. They may be fabricated with Very-large-scale integration (VLSI) techniques. A module and/or output may also be implemented in programmable hardware such as field programmable gate arrays, programmable array logic, programmable logic devices or the like. Modules may also be implemented in software for execution by various types of processors. In addition, the modules may be implemented as a combination of hardware and software in one embodiment.

An identified module of programmable or executable code may, for instance, include one or more physical or logical blocks of computer instructions that may, for instance, be organized as an object, procedure, or function. Components of a module need not necessarily be physically located together but may include disparate instructions stored in different locations which, when joined logically together, include the module and achieve the stated function for the module. The different locations may be performed on a network, device, server, and combinations of one or more of the same. A module and/or a program of executable code may be a single instruction, or many instructions, and may even be distributed over several different code segments, among different programs, and across several memory devices. Similarly, data or input for the execution of such modules may be identified and illustrated herein as being an encoding of the modules, or being within modules, and may be embodied in any suitable form and organized within any suitable type of data structure.

In one embodiment, the system, components and/or modules discussed herein may include one or more of the following: a server or other computing system including a processor for processing digital data, memory coupled to the processor for storing digital data, an input digitizer coupled to the processor for inputting digital data, an application program stored in one or more machine data memories and accessible by the processor for directing processing of digital data by the processor, a display device coupled to the processor and memory for displaying information derived from digital data processed by the processor, and a plurality of databases or data management systems.

In one embodiment, functional block components, screen shots, user interaction descriptions, optional selections, various processing steps, and the like are implemented with the system. It should be appreciated that such descriptions may be realized by any number of hardware and/or software components configured to perform the functions described. Accordingly, to implement such descriptions, various integrated circuit components, e.g., memory elements, processing elements, logic elements, look-up tables, input-output devices, displays and the like may be used, which may carry out a variety of functions under the control of one or more microprocessors or other control devices.

In one embodiment, software elements may be implemented with any programming, scripting language, and/or software development environment, e.g., Fortran, C, C++, C#, COBOL, Apache Tomcat, Spring Roo, Web Logic, Web Sphere, assembler, PERL, Visual Basic, SQL, SQL Stored Procedures, AJAX, extensible markup language (XML), Flex, Flash, Java, .Net and the like. Moreover, the various functionality in the embodiments may be implemented with any combination of data structures, objects, processes, routines or other programming elements.

In one embodiment, any number of conventional techniques for data transmission, signaling, data processing, network control, and the like as one skilled in the art will understand may be used. Further, detection or prevention of security issues using various techniques known in the art, e.g., encryption, may also be used in embodiments of the invention. Additionally, many of the functional units and/or modules, e.g., shown in the figures, may be described as being “in communication” with other functional units and/or modules. Being “in communication” refers to any manner and/or way in which functional units and/or modules, such as, but not limited to, input/output devices, computers, laptop computers, PDAs, mobile devices, smart phones, modules, and other types of hardware and/or software may be in communication with each other. Some non-limiting examples include communicating, sending and/or receiving data via a network, a wireless network, software, instructions, circuitry, phone lines, Internet lines, fiber optic lines, satellite signals, electric signals, electrical and magnetic fields and/or pulses, and/or the like and combinations of the same.

By way of example, communication among the users, subscribers and/or server in accordance with embodiments of the invention may be accomplished through any suitable communication channels, such as, for example, a telephone network, an extranet, an intranet, the Internet, cloud based communication, point of interaction devices (point of sale device, personal digital assistant, cellular phone, kiosk, and the like), online communications, off-line communications, wireless communications, RF communications, cellular communications, Wi-Fi communications, transponder communications, local area network (LAN) communications, wide area network (WAN) communications, networked or linked devices and/or the like. Moreover, although embodiments of the invention may be implemented with TCP/IP communications protocols, other techniques of communication may also be implemented using IEEE protocols, IPX, Appletalk, IP-6, NetBIOS, OSI or any number of existing or future protocols. Specific information related to the protocols, standards, and application software utilized in connection with the Internet is generally known to those skilled in the art and, as such, need not be detailed herein.

In embodiments of the invention, the system provides and/or receives a communication or notification via the communication system to or from an end user. The communication is typically sent over a network, e.g., a communication network. The network may utilize one or more of a plurality of wireless communication standards, protocols or wireless interfaces (including LTE, CDMA, WCDMA, TDMA, UMTS, GSM, GPRS, OFDMA, WiMAX, FLO TV, Mobile DTV, WLAN, and Bluetooth technologies), and may be provided across multiple wireless network service providers. The system may be used with any mobile communication device service (e.g., texting, voice calls, games, videos, Internet access, online books, etc.), SMS, MMS, email, mobile, land phone, tablet, smartphone, television, vibrotactile glove, voice carry over, video phone, pager, relay service, teletypewriter, and/or GPS and combinations of the same.

Embodiments of the present invention provides a method and system for assessing and diagnosing for a given individual across the multiple dimensions that comprise leadership skills which when applied satisfies the above-mentioned functional needs of the organization.

The method and system involve obtaining ratings by different combinations of relevant constituencies (subordinates, peers, and superordinates) along with the reasons, both positive and negative, underlying each rating for each dimension of leadership across the levels or tiers. In addition, the subject individual also rates him or herself across all leadership dimensions, and provides the bases (+ and −) of their respective ratings, which provides a basis for comparison to those of the raters, thereby permitting the assessment of the accuracy of their own self perceptions.

The ratings' summary, self and raters, across the dimensions nested within the leadership trait levels or tiers are presented in a hierarchical graphical format. The underlying reasons, both positive and negatives are organized and presented in a graphical listing format for each rating dimension. The ability to assess rater bias is also provided, thereby permitting the exclusion of that data in the summary analysis.

The analysis of the output, both the quantitative ratings and the qualitative diagnostics, is summarized for the individual and formal recommendations are developed. These recommendations provide the benchmark to determine relative improvement from subsequent assessments and for developing counseling agendas for those individuals which it is thought to be warranted.

Benchmark data from prior assessments by organizational level and function can be used as a basis for identifying fast-track individuals within the organization to optimize their leadership experiences.

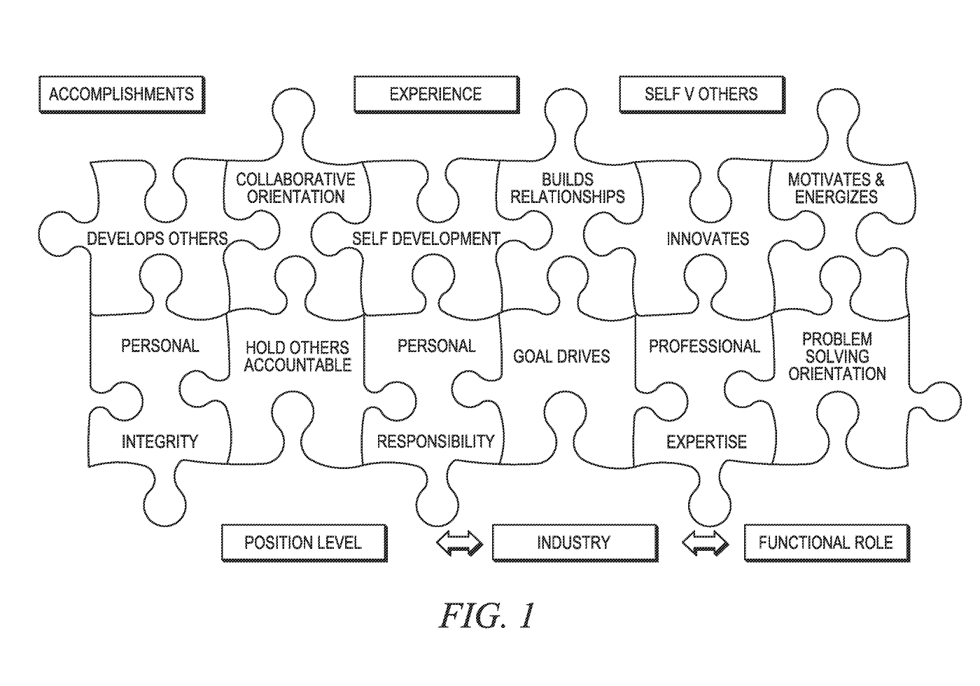

FIG. 1 illustrates a key framework in view of leadership framing contextual variables and personal traits and skills pivotal to an organization according to an embodiment.

It is recognized that the goal of a business entity is to create strategic equity which has two dependent, interrelated processes: strategic vision resulting in marketplace success, which results from management leadership and execution. In the marketplace, domain strategic equity is a function of increasing loyal customers which is logically preceded by strategies to increase repeat purchase of the organization's products or services. There is an express deterministic role of the management of the organization to maximize such domain strategic equity, which is a function of leadership quality and strategic vision. Strategic equity in the management domain, then, is a direct function of increasing both the quality and quantity of a number of multi-dimensional sets of success-defining skills, including leadership or other performance competences.

Leadership is linchpin to the dual functions of recognizing marketplace opportunities and efficiently managing the challenging process of implementing executional tactics. The key question of interest in this area is how to best leverage this fundamental understanding of this formula for business success. That is, how to develop a methodology to maximize the long-term Leadership Quotient (LQ) across a business organization?

Recognizing the strategic importance of increasing the LQ of the organization necessarily points to two realities. One, leadership traits may be recognized in view of leadership framing contextual variables defined in terms of dimensions and sub-dimensions reflective of personal orientations and the leverageable byproducts of successfully translating these traits to leading and energizing the team. Two, what is required to continually increase the LQ of the organization is a valid means of quantitative assessment that necessarily provides the underlying basis of the ratings in terms of diagnostics, both positive and negative, with respect to each leadership trait. It would be these diagnostics that provides the basis for constructing a concrete development plan. As noted, assessing the longitudinal progress of an individual with regard to these growth recommendations serves as a basis for employee evaluation.

In an embodiment, the present invention presents a novel method and system for assessing and providing specific diagnostics for the purpose of directing the development of the leadership skills of employees, especially with respect to the higher levels within the business organization. In another embodiment, the present invention may be used to perform assessment and diagnostics of general performance skills and traits of employees of all levels within the organization.

In particular, an embodiment of the present invention is directed to a method and system for assessing the leadership skills and potential of individuals, particularly those at the managerial level and above. Data derived from this method and system provides an organizational database for tracking of the individual's progress as well as serves as the basis to compute norms for the organization by level and function. Also provided is the ability to develop norms across organizations, by level and function, which can serve as external criteria to assess existing management. The method and system can be utilized by the organization for individual assessment leading to management development planning facilitated by specific, constructive feedback and functional team optimization within the organization.

In an embodiment, the method and system may be implemented using a related combination of automated interfaces, administrative and analytical, and an evaluative review of the data leading to individual-specific recommendations for improvement. The evolving database of assessments provides a basis for developing norms to serve as further criteria for individual evaluation.

Referring to FIG. 1, it is noted that leadership skills and traits can be recognized by certain indicators. For example, a person's past accomplishments and experiences may demonstrate certain types of leadership attributes and potential, especially when the accomplishments and experiences are indicators of past success at leadership. Another indicator may include the person's ability to lead the advancement, growth, and development of himself as compared with and in conjunction with the ability to lead the advance, growth, and development of others. Other indicators may include the person's specific backgrounds in leadership (in addition to accomplishments and experiences) at various specific position levels, industry, and functional roles.

Through the indicators as leadership framing contextual variables, a number of dimensions of leadership can be realized embodying various personal traits and skills that are pivotal to an organization. These dimensions include develops others, collaborative orientation, self development, builds relationships, innovates, motivates & energizes, personal integrity, hold others accountable, personal responsibility, goal driven, professional expertise, and problem solving orientation. These dimensions may be further organized into tiers of sub-dimensions for the assessment and diagnostics method and system according to an embodiment, which is further described below.

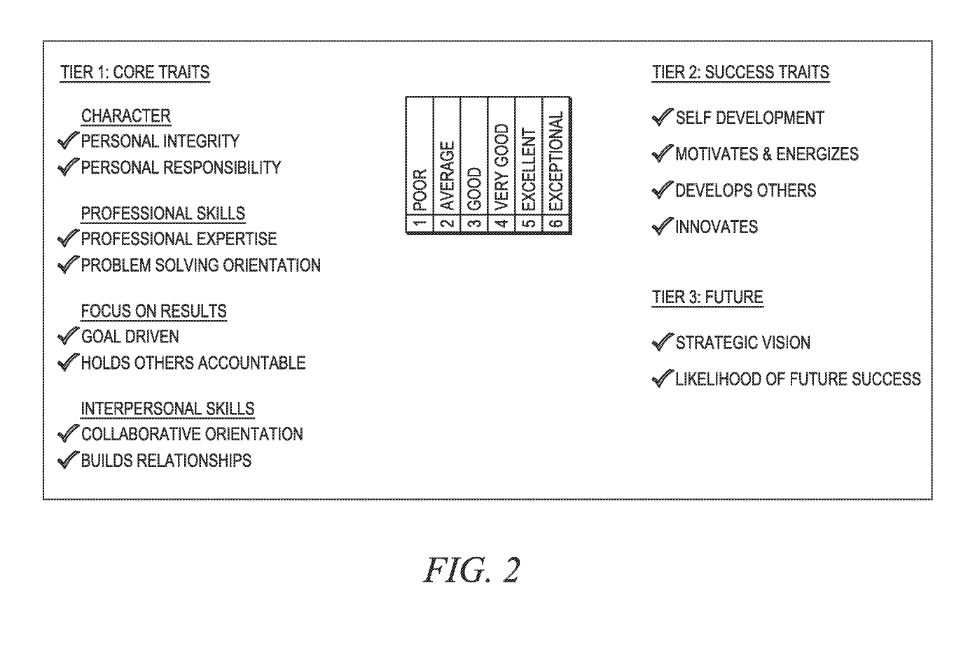

FIG. 2 illustrates a schema of personal leadership traits and skills as leadership dimensions and sub-dimensions grouped by tiers of leadership competencies according to an embodiment.

It is recognized that a strategic equity of an organization stems from personal assets or skills sets of the organization's leadership and these leaders' ability to foster and grow these identified key leadership traits within the management team to maximize long-term success for the organization. Understanding this fundamental reality should be the guiding principle that highlights the need for focusing on management development programs.

As such, central to designing and implementing such management development programs includes three understandings. First, leadership involves a multidimensional skills set, which, when demonstrated, is recognized and appreciated by others. Second, the most successful leadership skill development methods are labeled under cognitive-behavioral therapy, which needs to be grounded in concrete recommendations outlining a pathway for self-understanding and self-improvement. Third, feedback-based coaching over time increases the individual manager's propensity to seek advice and has been shown to successfully improve the manager's respective long-term skill sets.

Within these understandings, it is desirable to arrange the multidimensional leadership skills and traits sets into tiers of core and successively bridging and encompassing groups of leadership competency areas.

Referring to FIG. 2, the leadership skills and traits sets may be arranged into levels or tiers of leadership competency areas in order to understand the LQ skills of an individual according to embodiment. Further, these tiers naturally lead to a comprehensive framework of assessment and diagnostics of leadership of the individual according to an embodiment.

Tier 1 includes the core leadership skills and traits possessed by an individual. Here, there are four key individual competency areas that, when the person is coordinated with other members of the management team, the person should have the potential to build an exceptional organization. A successful leader should have four defining core traits or dimensions: character, professional skills, interpersonal skills, a focus on results. Each of these core traits may be described by two sub-traits or dimensions.

For the character dimension, a successful leader should demonstrate personal character (personal integrity) and takes responsibility for outcomes (personal responsibility). For the professional skills dimension, a successful leader should demonstrate specific professional expertise (expertise in specific functional areas) and a general ability to frame and solve business problems (problem solving orientation). For the focus on results dimension, a successful leader should demonstrate a results-orientation mentality (goal driven) and an ability to assess and address deficiencies within the organization (holding others accountable). For the interpersonal skills dimension, a successful leader should demonstrate interpersonal skills by building relationships (building positive relationship and trust with the clients and/or colleagues) and have a collaborative orientation (team mentality).

Tier 2 includes success traits that are bridging competencies providing a defining framework for developing outstanding strategic leadership within the organization. These bridging competencies have a multiplicative effect on the anchoring of the individual competencies (e.g., core traits of Tier 1).

A highly successful leader is recognized by others in the organization as: driven to increasing personal knowledge and skill sets (self development), motivating of others within the organization (motivates), effective in developing the professional and leadership skills of others within the team (develop others), and consistently developing innovative insights to address business challenges (innovates).

Tier 3 is defined by having a strategic vision, having an insight into both the current and future dynamics of the marketplace (e.g., in recognizing and defining the optimal business opportunity spaces). The best leaders should have a strategic vision or a clear insight into the underlying dynamics of both the current and future marketplace and recognizing the optimal opportunities for long-term growth. Also, importantly, this insight must include the ability to learn from failure and take responsibility. It is noted that this assessment may be more important for the more senior-level position assessments.

In Tier 4, it is recognized that exception strategic leadership requires an understanding of how to assess, communicate, and track the strengths and weaknesses of each team member as well as identifying the degree of discrepancies in contrast to self assessment. For example, a highly successful leader will have a high leadership IQ, defined by a self-awareness of one's own leadership core competency traits (as opposed to either/or their superordinate and subordinate perceptions). For this Tier 4, a methodology for the subject to assess all sub-dimensions of leadership is needed to serve as a contrast to the reality of the assessments of others. Also, importantly, the ability to track a given subject's progress over time relative to specific recommendations offers a highly desirable viewpoint for senior management and HR.

In an embodiment, assessment of Tiers 1, 2, and 3 traits of the individual may be quantitatively measured by a 6-point scale, with the value 1 being the lowest and the value 6 being the highest mark. For example, the values of the 6-point scale may be qualitatively described as 1 being poor, 2 being average, 3 being good, 4 being very good, 5 being excellent, and 6 being exceptional for the individual having respective trait being assessed.

It is understood that this quantitative assessment would be rated based on the subjective perceptions of a rater of the individual (e.g., the individual or others within the organization that have worked with the individual). As such, rater bias may be introduced by each of the rater and may be accounted for by analysis as will be described below.

In an embodiment, other raters within the organization themselves may be grouped to fit into groups of superordinates, peers, and subordinates of the individual. It is noted that an additional benefit of such a formal leadership trait assessment methodology is optimizing team composition, that is, making sure that all core competencies are present in each to ensure successful performance of the group.

In an embodiment, Tier 4 assessment may be derived through assessments of Tiers 1, 2, and 3 traits of the individual by the individual and others within the organization. For this Tier 4 assessment, the other raters within the organization themselves may be grouped to fit into groups of superordinates, peers, and subordinates of the individual (as discussed above). This is helpful in assessing the ratings of the individual by members of each group as a group for a comparison and contrast of the provided ratings as a group. The Tier 4 assessment method will be further described below.

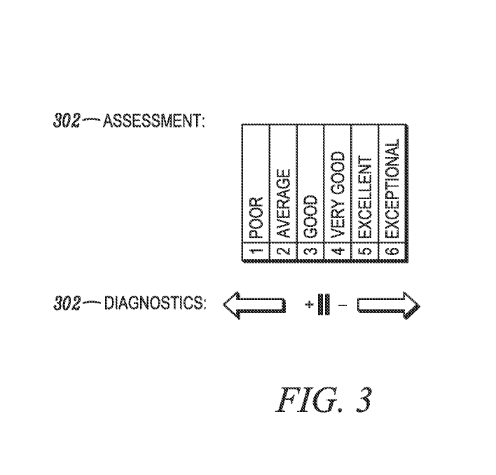

FIG. 3 illustrates an exemplary leadership assessment rating scheme according to an embodiment.

Referring to FIG. 3, in an embodiment, the leadership assessment rating scheme includes a quantitative assessment 301 of the individual to leadership traits (e.g., Tiers 1, 2, and 3 traits) process by the individual and others raters within the organization using the 6-point scale. In one implementation, the quantitative assessment 301 of the individual for each trait may be obtained by interviewing or surveying each rater for a direct score (e.g., 1 being poor, 2 being average, 3 being good, 4 being very good, 5 being excellent, and 6 being exceptional) of the individual for the respective trait.

In an embodiment, the leadership assessment rating scheme also includes a qualitative diagnostic 302 in complement with the quantitative assessment 301 of each leadership traits by the individual and the other raters within the organization. In one implementation, the qualitative diagnostic 302 may include description provided by each rater for the respective leadership traits giving reasoning supporting the quantitative assessment 301 of the rater for the respective leadership traits.

In another implementation, the qualitative diagnostic 302 may include specific, bounding (+ and −) rationales contrasting the rater's quantitative assessment 301 for the respective leadership traits. That is, the rater's may provide descriptions for not rating the individual higher and lower than the provided value in the quantitative assessment 301 (e.g., if the rater rates a 4 to an individual for a trait, the rater may provide a reason for each of not rating the individual a 3 and a 5 for the trait). If the quantitative assessment 301 for a trait is at an extremum value (e.g., a value of 1 or 6 on the 6-point scale), the rater may provide a reason for not rating the individual for the trait at a less extreme value (e.g., a value of 2 or 5, respectively). This equity-based method for the qualitative diagnostic 302 will be further described below with respect to U.S. Pat. Nos. 7,769,626 and 8,301,482 to Reynolds et al. and Azuma et al., “A review of time critical decision making models and human cognitive processes,” Aerospace Conference, 2006 IEEE, p. 9; all of the aforementioned are herein incorporated by reference in their entirety.

U.S. Pat. Nos. 7,769,626 and 8,301,482 disclose a method and system that provide (a) a theoretical framework for designing psychological research that uncovers individual decision-making networks, both in terms of sampling requirements and questioning methods, and (b) an implementation interface to schedule and administer the appropriate question sequences between an interviewer and a given individual, in real-time, via a web-based system, and (c) a coding and analysis system to summarize and quantify the potential of alternative decision structures to be used to optimize the development of marketing and communication strategies.

In particular, the market research method and system provide assessments of the market (e.g., customer's likelihood of purchase/repurchase, customer loyalty, customer satisfaction, customer's beliefs or views of importance of attribute descriptors) and accurate assessments of the attributes of an object (e.g., a brand, company, organization, product or service) that will influence customers most if changed. The market research method and system analyzes the customer's responses to questions designed to elicit the customer's equity to the object. Here, the equity is a combination of customer belief and behavior built up over time that creates customer perceptions about the desirability (or undesirability) of the object, such equity being effective for inducing (or inhibiting potential) customers to perform transactions directed to the object. Ultimately, equity is a function of the customer's assessment of the market (e.g., customer's likelihood of purchase/repurchase, customer loyalty, customer satisfaction, customer's beliefs or views of importance of attribute descriptors).

Practically, the equity analysis process includes interviewing customers with positive equity questions (questions that request the interviewee to identify at least one of the most important positive aspects of the object being researched) and negative equity questions (question that requests the interviewee to identify at least one of the most important negative aspects of the object being researched). The response of the positive equity questions may be obtained by asking the customers to evaluate the object, and then presenting the positive equity question requesting the customers to recite an aspect (e.g., the positive aspect) of the object that is the basis for the rating the object at the responded importance (e.g., X) rather than a lesser importance (e.g., X−1). Similarly, the response of the negative equity questions may be obtained by asking the customers to evaluate the object, and then presenting the positive equity question requesting the customers to recite an aspect (e.g., the negative aspect) of the object that is the basis for the rating of the object at the responded importance (e.g., X) rather than a lesser importance (e.g., X+1). The equity leverage of an aspect of the object may then be obtained for the positive equity aspect and similarly for the negative equity aspect.

In an embodiment, the equity-based qualitative diagnostic 302 for the leadership traits may be analogous to the equity analysis of the marketing assessment of the object. By obtaining responses from the raters based on a positive equity and a negative equity of the respective traits, an on-the-margin assessment description of the qualitative response with the specific, bounding rationale may be obtained that is deemed more accurate and reliable to the overall assessment method and system (e.g., similar benefits as with the marketing assessment described above).

As such, the underlying bases of the ratings may be obtained through an on-the-margin type question framing methodology, which isolates the positive (+) equities and negative (−) barrier disequities. This on-the-margin type question framing methodology may have the rater to answer the following two exemplary questions for each trait (as also alternatively described above). For the positive equity question: “What is the one primary reason that causes you to rate ‘individual XXX’ a 3 and not a 2 (one point lower) on Leadership trait YYY?” For the negative equity question: “What is the one primary barrier that is the reason you do not rate ‘individual XXX’ a 3 and not a 4 (one point higher) on Leadership trait YYY?” Accordingly, this on-the-margin type question framing methodology is analogous to equity analysis process of U.S. Pat. Nos. 7,769,626 and 8,301,482 and shares similar benefits.

Azuma discloses the decision making processing from a general cognitive perspective as the process of selecting a choice or course of action from a set of alternatives. It is noted that the primary underlying cognitive processes, according to most, if not all, decision making models, have a focus on attention, working memory, and reasoning.

The framing issue for the equity-based method of the qualitative diagnostic 302 is to make or view such qualitative rating as judgments in a decision-making task. That is, the essence of the decision making of the raters is the key to understanding the basis of the qualitative rating decision. Focusing on the cognitive bases of contrasts (e.g., the equity-based responses to the qualitative diagnostic 302), the rater focuses his attention on the task in order to provide the best possible information from working memory, which is activated for this judgment task.

As such, the diagnostic information under the qualitative diagnostic 302 requires revealing the cognitive underpinnings of the decision process. This in-depth understanding for questioning the rater necessarily requires activating two cognitive processes; namely, increased attention on the judgment tasks involved thereby activating additional working memory in the brain. This is accomplished by the on-the-margin judgment task methodology of U.S. Pat. Nos. 7,769,626 and 8,301,482. This cognitive activating judgment task involves asking for the most important distinction that causes the rating to not be one point lower on the scale, and also what important distinction causes the rater to not rate the subject one point higher. The former is the primary positive equity and the latter is the primary negative barrier. Diagnostics, both positive and negative, obtained for each trait for each respondent provides the foundation for developing a definitive evaluation of the subject with specific recommendations for leadership skill improvement. In addition, to aid the prioritization of improvement recommendations, the raters may also be asked for each of the respective tiers of leadership dimensions which one would most directly increase in the individual subject's overall leadership skills development.

In an embodiment, the rater may be given an opportunity to change a quantitative assessment 301 for an assessed trait after the rater is presented with the corresponding equity-based qualitative diagnostic question. For example, both the quantitative assessment 301 and the qualitative diagnostic 302 for a trait is presented to the rater simultaneously (e.g., the rater may provide a score and the +/−equity reasoning for a trait before moving to the next trait for an assessment provided by an electronic system). Through this process, the rater may provide an generally more accurate assessment by internally cognizing a congruence between the quantitative assessment 301 and the qualitative diagnostic 302.

It is further noted that the simple fact is the individual can only improve if he or she gets accurate feedback, and this on-the-margin qualitative assessment method and system represents the fundamental underpinning of a successful leadership coaching program.

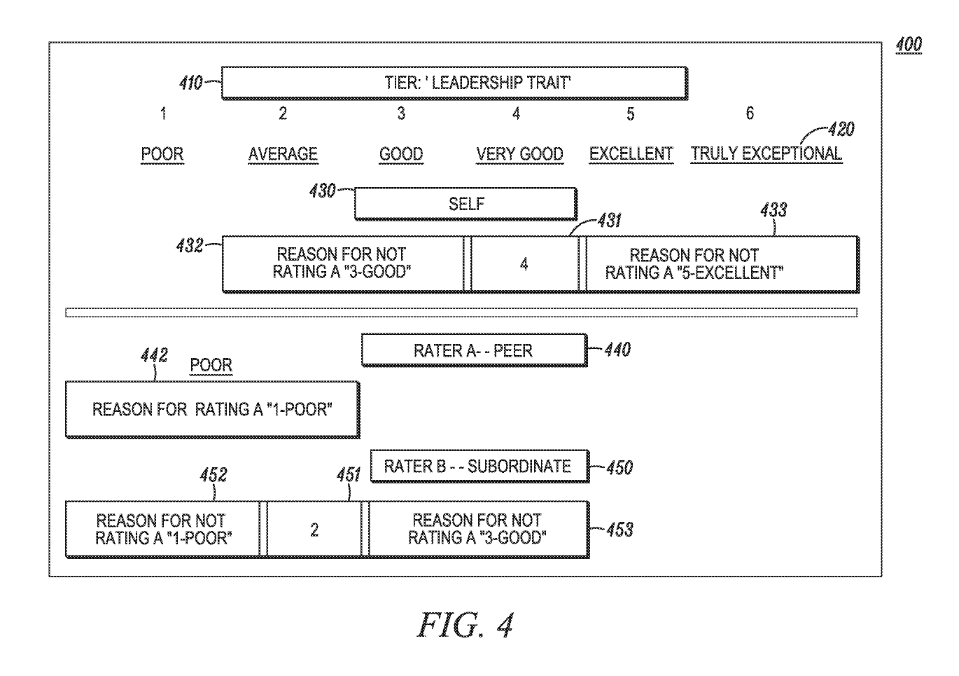

FIG. 4 illustrates an exemplary rating to leadership assessment rating scheme according to an embodiment.

Referring to FIG. 4, assessment rating scheme 400 includes a summary of the quantitative assessments (e.g., quantitative assessment 301) and the qualitative diagnostics (e.g., qualitative diagnostics 302) of a number of raters for a given leadership trait 410. For example, the leadership trait being reviewed here is some “Leadership Trait” in Tier 1; in a complete assessment, each leadership trait may have a similar summary.

Assessment rating scheme 400 also includes the quantitative assessment scale 420 (e.g., the 6-point scale) and a summary of ratings for the various raters: self 430, a peer rater 440, and a subordinate rate 450. Self rater 430 (e.g., the individual being assessed) gave himself a quantitative rating 431 of ‘4’ and giving himself qualitative rationales 432 and 433 for not rating himself one value lower and higher, respectively, for trait 410. Peer rater 440 gave the individual a quantitative rating 441 of ‘1’ and giving the individual qualitative rationale 432 for not rating the individual one value higher for trait 410. Subordinate rater 450 gave the individual a quantitative rating 451 of ‘2’ and giving the individual qualitative rationales 452 and 453 for not rating himself one value lower and higher, respectively, for trait 410.

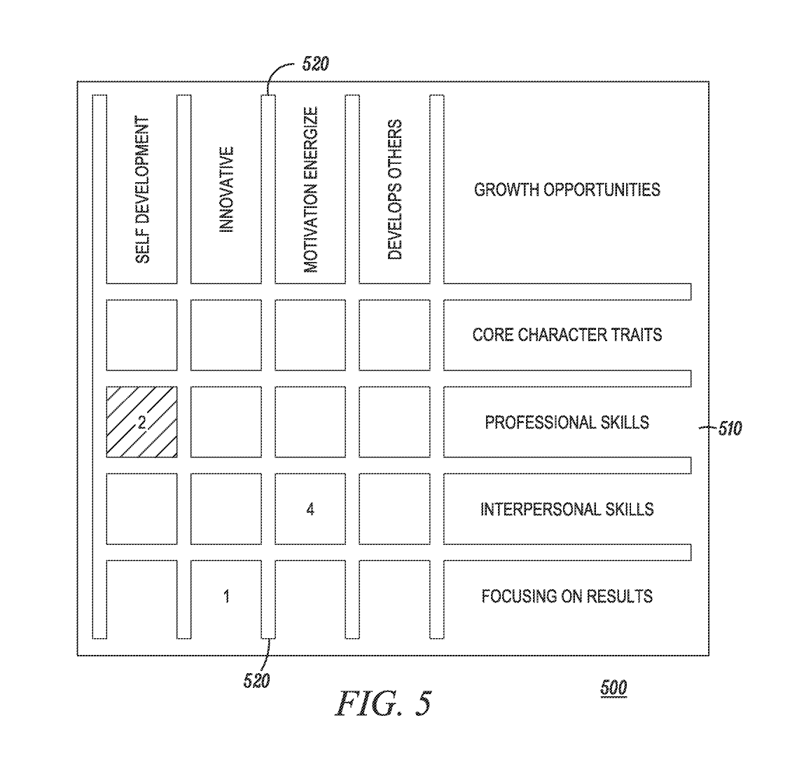

FIG. 5 illustrates an exemplary developmental recommendation based on ratings to leadership assessment rating scheme according to an embodiment.

Referring to FIG. 5, developmental recommendation 500 identifies the prioritized potential growth areas in the leadership skills and traits. Generally, the leadership assessment aggregates information on all areas (dimensions and sub-dimensions) of leadership skills and traits for the individual. In an embodiment, a developmental recommendation may be prioritized so that the assessed individual may focus on certain deficient leadership skills and traits.

It is further recognized that certain traits and skills may be more amendable to short-term (e.g., 1 year) improvements upon structured or unstructured training, practice, or experience. For example, competencies that include skills and attitude components (e.g., Tier 1 core trait and Tier 2 bridging competencies) may be better suited for short-term improvements than traits that may be further ingrained or intrinsic to the individual. Also, there is prospect and expectation incremental improvements to the lower tiers of leadership skills and traits may have a multiplicative effect leading to gradual improvements of the higher tiers of leadership skills and traits.

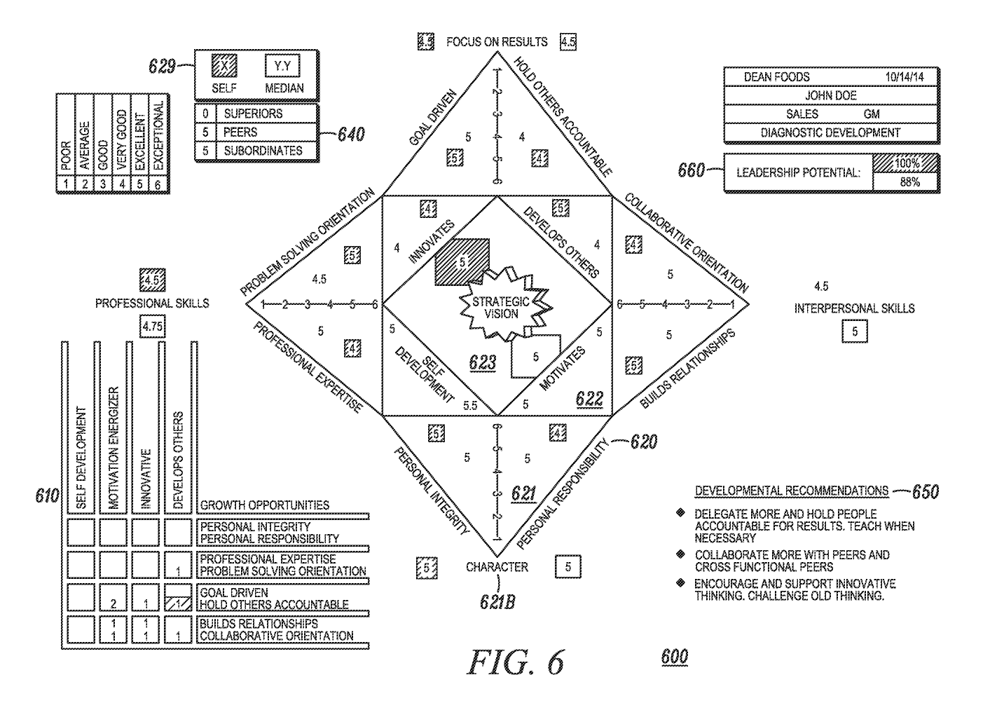

In an embodiment, the development recommendation 500 aggregates the lowest rated quantitative rating provided by each rater for each of the Tier 1 traits 510 and the Tier 2 traits 520. In one implementation, the Tier 1 traits 510 are further aggregated by the main dimensions (e.g., the dimension of core character traits instead of the sub-dimensions of personal integrity and personal responsibility). In another implementation, the Tier 1 sub-dimensions may be separately listed (e.g., developmental recommendation 610 as will be discussed with respect to FIG. 6).

The growth opportunity grid 530 lists the aggregation of the lowest rated traits from each rater. For example, out of a total of seven raters, one rater gave the lowest assessment for Tier 1 dimension of focusing on results and Tier 2 dimension of innovative for the individual. Four raters gave the lowest assessment for Tier 1 dimension of interpersonal skills and Tier 2 dimension of motivation & energize for the individual. Two raters, including the individual himself, gave the lowest assessment for Tier 1 dimension of professional skills and Tier 2 dimension of self development for the individual.

In another embodiment, each rater may be directly asked equity diagnostics questions to identify the trait (e.g., a Tier 1 and 2 trait) that, if the individual improved on, would result in an overall improvement in the subject's leadership. Further, the rater may be asked to give a description on a development recommendation directly (e.g., giving a specific example of how this improvement could be accomplished).

As such, the development recommendation 500 essentially forms an equity diagnostics in providing the foundational details for reinforcing the positive characteristics relative to each trait as well as the negative barriers which provide a specific coaching pathway to increasing leadership skills.

For example, in this growth opportunity grid 530, four raters (out of the total of seven raters) gave the lowest assessment for Tier 1 dimension of interpersonal skills and Tier 2 dimension of motivation & energize. Therefore, one may conclude that the Tier 1 dimension of interpersonal skills and Tier 2 dimension of motivation & energize is what the individual should specifically work on for maximal improvement to the individual's leadership (based on the opinion of a majority of the raters that these are the dimensions that the individual is most deficient and/or will have the most gain with their improvements). Accordingly, specific coaching may be devised for the individual to improve of these two identified dimensions.

In addition, the identification of these two dimensions by the majority of the raters contrasts specifically with the individual's self identification of Tier 1 dimension of professional skills and Tier 2 dimension of self development. This contrast may represent the individual's subjective assessment of improvements of the dimensions that would lead to maximal improvement as compared with the other raters' assessment. Accordingly, the specific coaching may be further structured with an acknowledgement of this contrast (acknowledgement by the individual and/or through the specific coaching's structure) for a more effective specific coaching.

Further, this developmental data may also provide a concrete basis to assess the individual's leadership development plan leading to a prioritized list of summary recommendations as will be discussed below with respect to FIG. 6.

In another embodiment, the developmental recommendation 500 may include other traits in place of Tiers 1 and 2 traits for other Tiers of leadership or other performance traits.

FIG. 6 illustrates an exemplary summary based on ratings to leadership assessment rating scheme according to an embodiment.

Referring to FIG. 6, summary 600 may include one or more of an integrated quantitative summary 620, and development recommendation grid 610 and developmental recommendation comments 650. The summary 620 is configured to present a summary of the qualitative assessment (e.g., qualitative assessment 301) provided by the various raters.

In an embodiment, the integrated quantitative summary 620 presents a summary of the raters' assessment of the individual for each of the leadership traits grouped by the Tiers. Here, Tier 1 summary 621 is presented at the outer edges of the integrated quantitative summary 620. Tier 2 summary 622 is presented at an inner portion of the integrated quantitative summary 620. Tier 3 summary 623 is presented at the innermost portion of the integrated quantitative summary 620.

Each of the traits (dimensions and sub-dimensions) for all tiers are presented with individual quantitative scores 629: one for of the self assessment and an aggregate score for the assessment by other raters. For the aggregate score by the other raters, the aggregation may use the median, average, or other statistical or other methods to derive the aggregate score. The presentation of the self score and the aggregate score of other raters provide an instant comparison of the perception of leadership by the self and by the other raters. This comparison provides an indirect presentation of Tier 4 comparative traits in a simple visual contrast.

In one embodiment, significant discrepancies for this Tier 4 assessment (e.g., when the self assessment contrasts significantly with the assessment by other raters) can be highlighted for further visual contrast. For example, when, for a trait, the score of a self assessment differs from the aggregated score over a certain threshold value, the difference in the score can be highlighted for that specific trait (dimension/sub-dimension).

In an embodiment, the other raters may be grouped by their respective positions as a relational classification 640 to the individual. In this exemplary summary 600, the individual was rated by 5 peers and 5 subordinates but no superiors. This relational classification 640 is provided as a reference in this summary 600 but may be used for further analysis on the compare and contrast of the assessment among the groups (e.g., self, superiors, peers, subordinates) as will be described below.

It is noted that the integrated quantitative summary 620 may include a number of different presentation configurations. Here, both the sub-dimensions and the dimensions of the Tier 1 traits are presents as separate summaries 621 and 621A, respectively. It is also noted that the development recommendation grid 610 presents the Tier 1 sub-dimensions as opposed to the dimensions (e.g., development recommendation grid 530).

In an embodiment, the summary 600 may include some sort of developmental recommendation comments 650. In one implementation, the developmental recommendation comments 650 may be comments in word descriptions related to the pattern of the quantitative assessment as presented in the summary 600. For example, one or more of the developmental recommendation comments 650 may be directed towards a deficiency of one or more traits as shown in the integrated quantitative summary 620. In another example, deficiencies or a pattern of assessment score in a combination of traits (e.g., detected by various pattern matching implementation as known now or may be later derived) may result a customized comment matching the particular pattern. A goal of the developmental recommendation comments 650 is to provide an easy to read and understand written description presentation of the assessment and diagnostic results and recommendations for a human (e.g., the individual, trainer, human resources). In another implementation, the developmental recommendation comments 650 may also include instances of the qualitative diagnostic (e.g., equity-based qualitative diagnostic) as discussed above with respect to FIG. 3.

In a further embodiment, the integrated quantitative summary 620 may also include an assessment of the leadership potential 660 of the individual as rated by the self and other raters.

It is recognized that the assessment provided by the other raters may naturally include some sort of subjective bias. This may affect the accuracy and precision of the aggregate score of the other raters, which is based on any of a number of statistical methods such as the mean and median. In an embodiment, this subjective rater's bias may be removed through statistical or other analysis (e.g., regression analysis, outlier analysis) as known now or may be later derived.

It is further recognized that, among the other raters, certain raters may have more reliability than other raters at rating all or some of the traits (e.g., based on the position of the rater such as peer raters of the same group as the individual or direct superordinate or subordinate of the individual, based on the nature of the working relationship with the individual such as working with the individual on a task that predominate certain leadership traits from the individual). In an embodiment, a relative importance can be ascribed to a rater for all or some of the traits (e.g., by weighing the assessment of these raters with more or less importance). As such, when the scores from the other raters are aggregated into the aggregate score, the relative importance of certain raters can be reflected in the aggregate score. This can also serve as another method to remove subjective raters bias by allowing certain raters deemed more reliable higher weights.

Table 1 lists exemplary arithmetic weightings for a 6-point assessment scale for an individual of various organizations, organizational roles, and experience/position level according to an embodiment.

TABLE 1

| Trait | Type I | Type II | Type III |
|---|---|---|---|
| Personal integrity | | | |
| Personal | | | |
| responsibility | | | |
| Professional | −0.5 | +0.5 | −0.5 |
| expertise | | | |
| Problem solving | −0.5 | +0.75 | −0.5 |
| orientation | | | |
| Collaborative | | | |
| orientation | | | |
| Builds relationships | +0.5 | −0.5 | |
| Goal driven | +0.75 | | |
| Holds others | −0.5 | | +0.5 |
| accountable | | | |
| Self Development | +0.5 | | |
| Innovates | | −0.25 | |
| Motivates and | +0.5 | | −0.5 |
| Energizes | | | |
| Develops Others | | −0.5 | |
| Strategic Vision | −0.75 | | |

It is recognized that objective ratings on key multidimensional leadership traits may be assessed based upon historical norms relative to specific combinations of industry, respective position within the organization, and level of the subject's experience. This, in addition to the contrasting of differences across and between self ratings and those of key groups within the organization (superior, peer and subordinate) as discussed above, can provide additional insights into functional realities within the organization with respect to the leadership skills.

In an embodiment, it is further recognized that an individual with a certain combination of organization type (e.g. law enforcement, small business, technology, or manufacturing), organizational role (e.g. sales, engineering, finance or marketing), and/or experience/position level (e.g., novice, fast track, middle or senior management) may need more or less of a certain leadership trait (or alternatively requires a more critical scrutiny of certain leadership trait).

Referring to Table 1, exemplary weightings are given for Types I, II, and III of various organization types, organizational roles, and experience/position levels. Type I weightings may include organization type of small business (e.g., direct sale), organization role of sales, and experience/position level of novice. Type II weightings may include organization type of technology, organization role of engineering (e.g., R&D), and experience/position level of middle management. Type III weightings may include organization type of manufacturing, organization role of finance, and experience/position level of senior management.

In an embodiment, additional analytical options in complement to the ability to develop norms by combinations of different organizations, functional areas within the organizations, and experience/position levels within the respective organizations may include tracking the longitudinal progress of individuals (e.g., comparing the assessment of an individual over time).

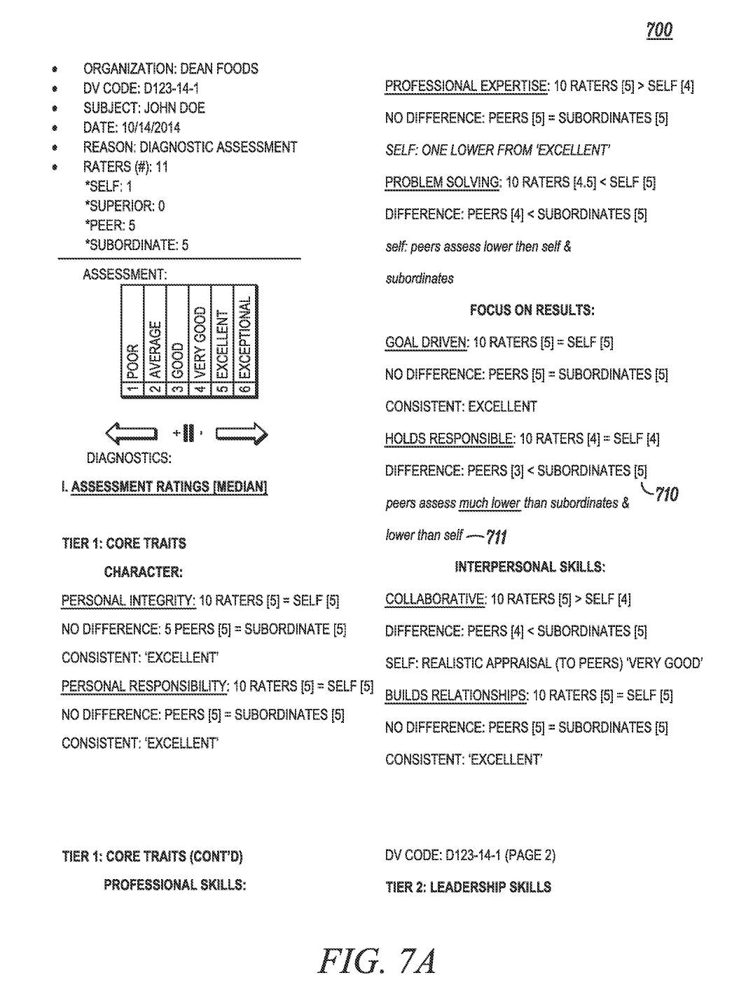

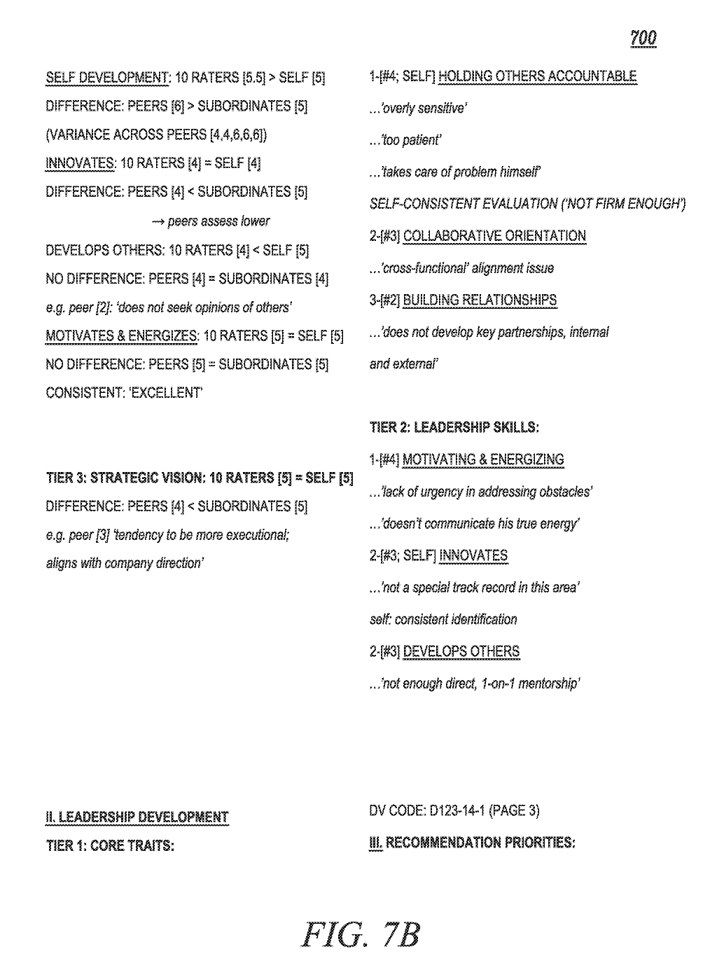

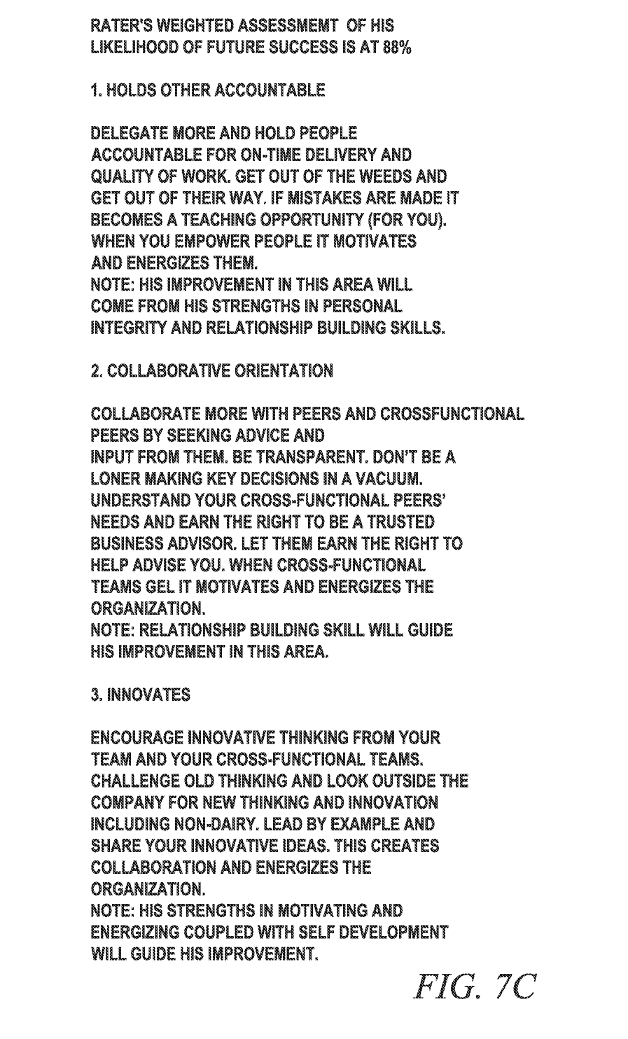

FIGS. 7A-7C illustrate exemplary descriptive summaries based on ratings to leadership assessment rating scheme according to an embodiment.

Referring to FIGS. 7A-7C, the descriptive summaries 700 provide an alternate and complementary presentation of the results of a leadership assessment and diagnostic. For example, descriptive summaries 700 may present similar information as presentable by chart-based summaries (e.g., summary 600 with integrated quantitative summary 620). In an embodiment, the descriptive summaries 700 may present further assessment summaries related to description given by the raters for the qualitative diagnostic of a trait (e.g., comments on the rater's quantitative score and/or responses to the on-the-margin questions) because such information may not be easily presented in a chart-based summary.

In an embodiment, the descriptive summaries 700 may present further information related to the comparative rating differences among raters of the various groups (e.g., self, superordinates, peers, and subordinates). This includes one or more of self to other raters comparison (e.g., similar to the self score and aggregate score comparison as noted in summary 600) and comparisons among rater groups. This may show meaningful comparisons that may not be apparent when only comparing the self with other raters as a large group. For example, in the descriptive summaries 700, rating comparison 710 notes that the trait “holds others responsible” was rated by the self with a score of ‘4’, which is the same score for the average of all 10 raters. However, when comparing the assessment of the 10 raters as subgroups of 5 peers and 5 subordinates 711, it is apparent that the aggregate score, ‘3’, from the peer raters is much lower than the aggregate score, ‘5’, from the subordinate rater and also the self, ‘4’. This difference would not be apparent, as noted, without comparing assessment of the different subgroups.

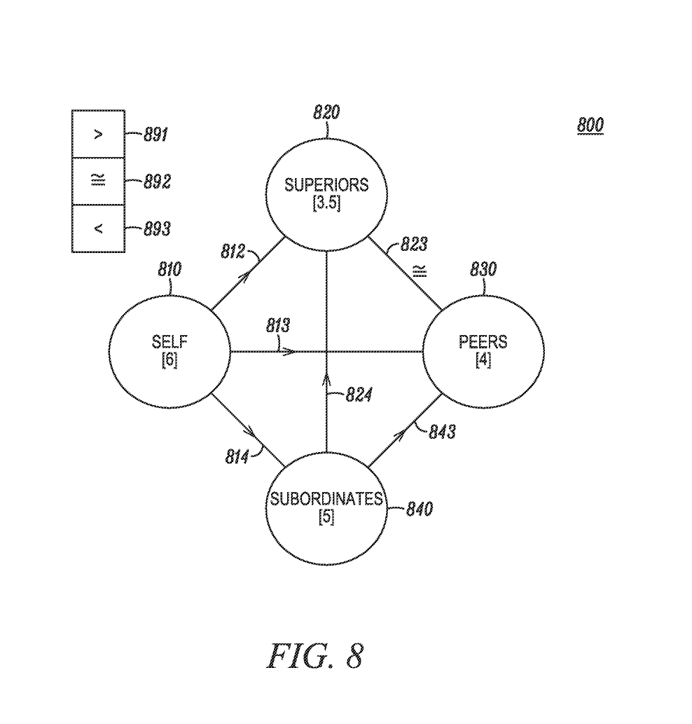

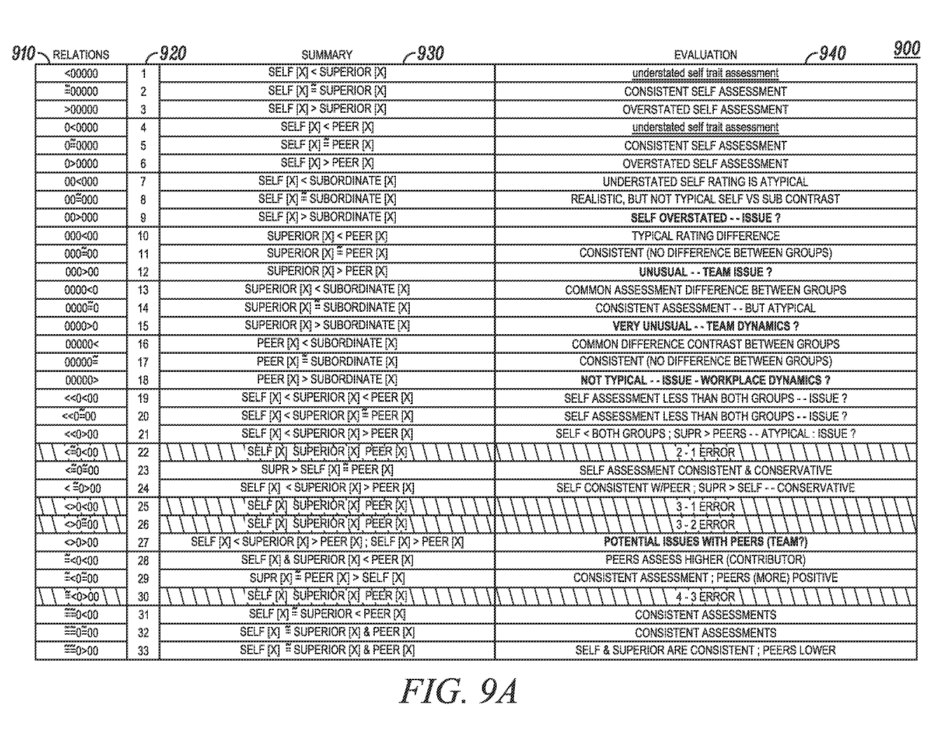

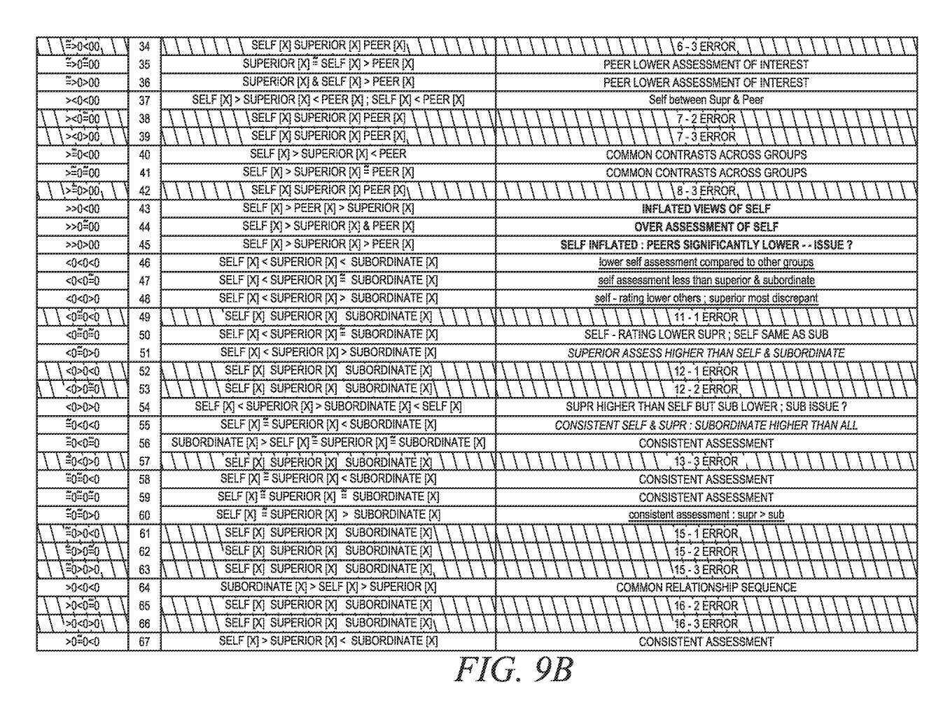

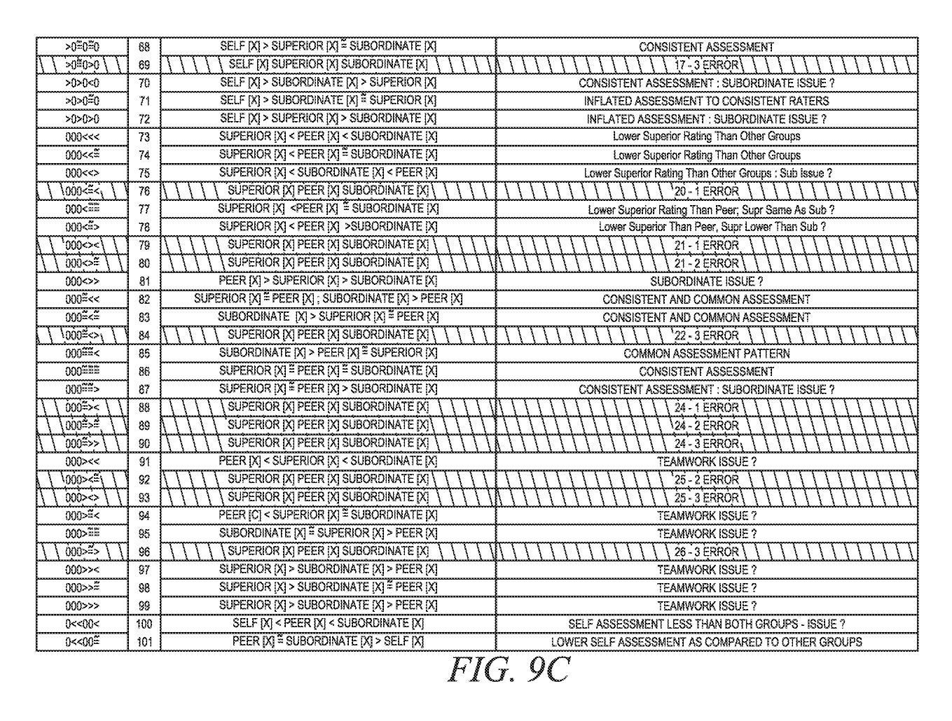

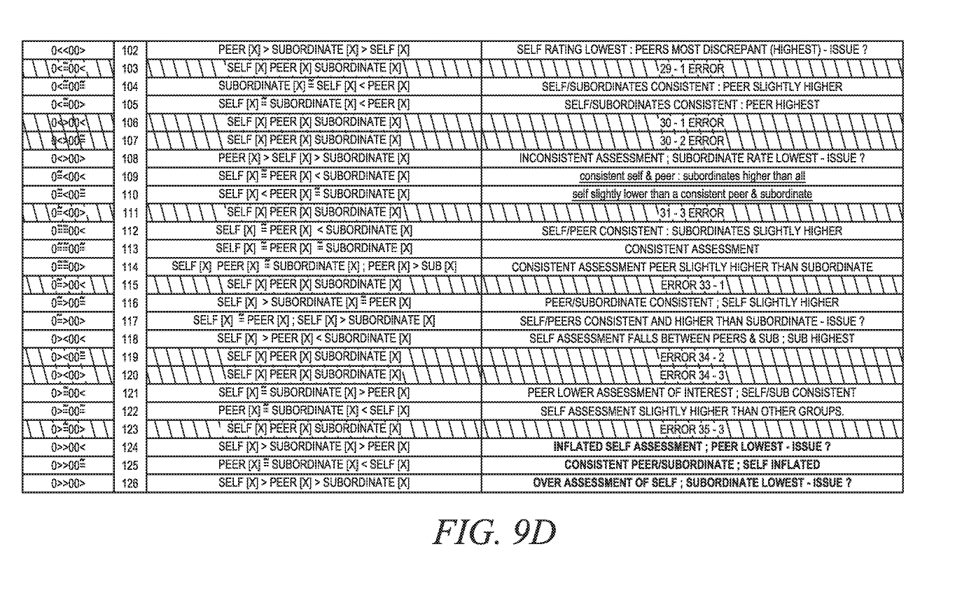

In another embodiment, the descriptive summaries 700 may further include analysis on the differences of assessment by the different subgroups, which will further be described below with respect to FIGS. 8 and 9A-D.

FIG. 8 illustrates an exemplary relational diagram rating differences among rater groups for ratings to leadership assessment rating scheme according to an embodiment.

Referring to FIG. 8, relational diagram 800 lists a number of possible relationship paradigm of the assessment ratings of various raters within groups of self 810, superiors/superordinates 820, peers 830, and subordinate 840 when analyzing ratings for a trait. There are six possible comparative relationships resulting from these four groups, the self to superiors relationship 812, the self to peers relationship 813, the self to subordinates relationship 814, the superiors to peers relationship 823, the superiors to subordinates relationship 824, and the peers to subordinates relationship 843. These six comparative relationships each have three possible comparisons, the first group's aggregate rating being greater than the second group's aggregate rating 891, the first group's aggregate rating being approximately equal to the second group's aggregate rating 892, and the first group's aggregate rating being less than the second group's aggregate rating 893. In an embodiment, the approximately equal comparison 892 may hold if the difference between the first and second group's aggregate rating is within a predetermined value (e.g., 0.5).

In the example of the relational diagram 800 here, the self 810 has given a rating of ‘6’ for a trait, the superiors 820 have given an aggregate rating of ‘3.5’ for the trait, the peers 830 have given an aggregate rating of ‘4’ for the trait, and the subordinates 840 have given an aggregate rating of ‘5’ for the trait. As such, for this trait in this relational diagram, the following relationships follow: the self rating is greater than the superiors rating in the self to superiors relationship 812, the self rating is greater than the peers rating in the self to peers relationship 813, the self rating is greater than the subordinates rating in the self to subordinates relationship 814, the superiors rating is approximately equal to the peers ratings in the superiors to peers relationship 823, the superiors rating is less than the subordinates rating in the superiors to subordinates relationship 824, and the peers rating is less than the subordinates rating in the peers to subordinates relationship 834. Evaluation of this and other relationships will be discussed below with respect to FIGS. 9A-D.

FIGS. 9A-D illustrate exemplary evaluation charts of rating differences among rater groups for ratings to leadership assessment rating scheme according to an embodiment.

Referring to FIGS. 9A-D, chart 900 lists evaluations 940 of differences in ratings of a leadership trait assessment among raters of different groups. Column 910 lists the relationship for each row 920, and column 930 lists a summary of the relationship.

In further details, each two of the relations column 910 contains six symbols representing the relationships of the rater groups in the order as follows: the self to superiors relationship, the self to peers relationship, the self to subordinates relationship, the superiors to peers relationship, the superiors to subordinates relationship, and the peers to subordinates relationship. These six comparative relationships each have three possible comparisons, the first group's aggregate rating being greater than the second group's aggregate rating, the first group's aggregate rating being approximately equal to the second group's aggregate rating, and the first group's aggregate rating being less than the second group's aggregate rating, using symbols similar to as described with respect to comparisons 891, 892, and 893 of FIG. 8. The summary column 930 summaries, with a description, the relationship represented by the relations of column 910.

Rows 1-18 each lists one comparative relationship (e.g., between only a first group and a second group).

Rows 19-126 each lists multiple comparative relationships. That is, the corresponding evaluation 940 is provided for a combination of two or more comparative relationships (e.g., among at least a first group, a second group, and a third group). Here, the multiple comparative relationships may contain an inconsistent error between at least one relationship. For example, row 21 describes relations of a self rating less than the superiors rating, a self rating approximately equal to the peers rating, and a superiors rating less than the peers rating. This is an impossible scenario and produces an inconsistent error.

In an embodiment, the evaluation 940 lists an analysis of the relation (e.g., based on empirical or other data) other than relations that would produce an inconsistent error.

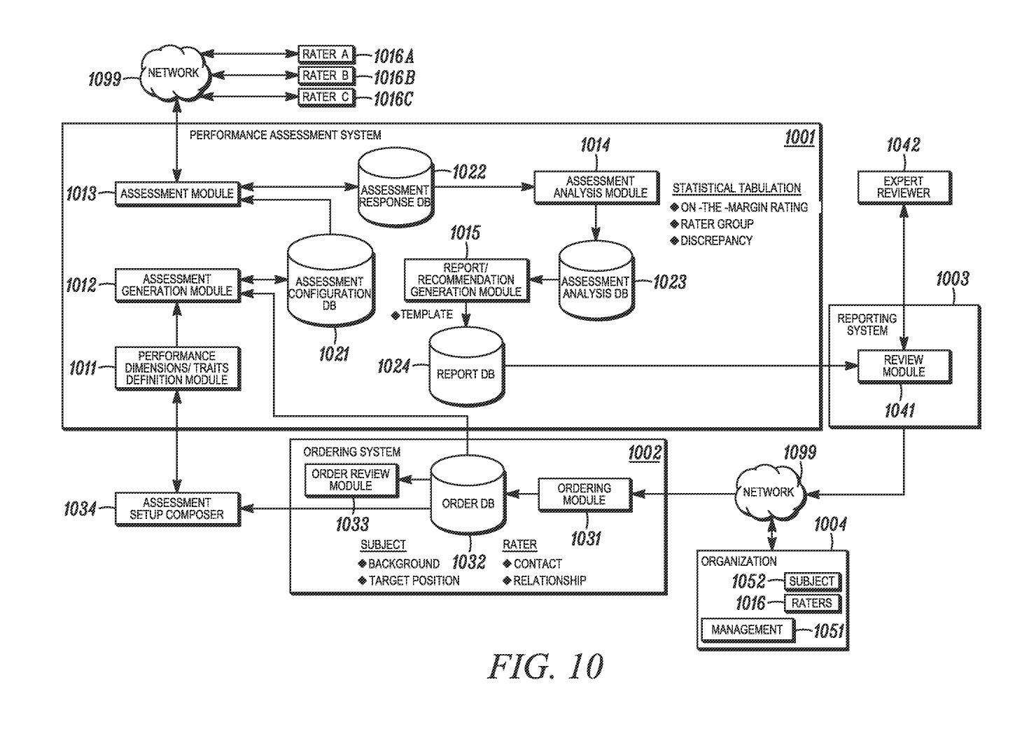

FIG. 10 illustrates a systems diagram of a performance assessment system and related systems according to an embodiment.

Performance assessment system 1001 includes one or more of performance dimensions/traits definition module 1011, assessment generation module 1012, assessment module 1013, assessment analysis module 1014, and report/recommendation generation module 1015. The performance assessment system 1001 also includes one or more of the assessment configuration database 1021, assessment response database 1022, assessment analysis database 1023, and report database 1024. The performance assessment system 1001 is configured to generate a suitable assessment to evaluate the performance of an individual, administrate the evaluation of the performance of the individual to one or more raters, aggregate and analyze the evaluations from the raters, and to generate a report and/or recommendation for improvement of the performance of the individual based on the evaluations.

The performance dimensions/traits definition module 1011 is used to define various dimensions and/or sub-dimensions of various traits of the performance being assessed. For example, leadership traits may be defined by the 4 Tiers of dimensions and sub-dimensions as described above with respect to FIG. 2. In other examples, for non-leadership positions, skills-based performances involving interactions with other people (e.g., teaching, direct sales) may be suitable for evaluation using the performance assessments system 1001.

In an embodiment, the performance dimensions may be predefined and would not need definitions by the performance dimensions/traits definition module 1011 (e.g., for leadership dimensions that are described above). For other performances, the dimensions and traits may be defined by an assessment setup composer 1034, who may setup the dimensions and traits within the specification of the organization 1004 who is requesting the assessment and/or with an expert in the field of the performance being assessed similar to the leadership traits described above (e.g., with respect to FIG. 2).

The assessment generation module 1012 uses the dimensions/traits generated by the performance dimensions/traits definition module 1011 or predetermined traits stored for the performance in order to generate a customized assessment for the performance being assessed. Here, the assessment may include a combination of qualitative and quantitative assessments to be rated and answered by a number of raters for the various traits/dimensions for the individual. For example, the assessment may use qualitative assessment of rating within a 6-point scale (or other types of ratings) and the on-the-margin equity quantitative diagnostic in conjunction with the qualitative rating as discussed above with respect to FIG. 3. The generated assessment can be stored in the assessment configuration database 1021.

The assessment module 1013 is configured to serve the assessment generated by the assessment generation module 1012 to the various raters and retrieve the assessment evaluation returned by the various raters.

In an embodiment, the raters are pre-identified by the organization 1004 as raters suitable for rating the individual for the performance assessed. The assessment module 1013 may communicate with the various raters 1016A-C through a network (e.g., the Internet) or by other methods (e.g., a locally connected workstation to the performance assessment system 1001, an offline method such as phone call, postal mail) to send an invitation to the raters 1016A-C to evaluate the assessment within a time period.

The assessment module 1013 retrieves the generated assessment from the assessment configuration database 1021 to be served to the raters 1016A-C at a time of the evaluation. The raters 1016A-C may each be served individually or simultaneously depending on the need of the assessment and/or how and when the raters 1016A-C requests the assessment to be served to them (e.g., clicking on a hyperlink in the invitation to serve the assessment through the network 1099, being on a server website at a specific time for all raters 1016A-C to evaluate the assessment simultaneously).

In a preferred embodiment, the assessment may take the form of an electronic survey. The survey may be served to the raters 1016A-C through the network as a website. The raters 1016A-C may navigate the website in order to complete the survey (e.g., providing answer to a set of questions and clicking on a “submit” button to moving onto the next question). In one implementation, questions related to the same trait (e.g., quantitative question for providing a rating to a trait and the corresponding qualitative on-the-margin questions for the rating) may be provided on the same page such that the rater may provide answers to the entire set of questions, have an opportunity to review and correct any of the provided answers, before moving on to the next set of questions for another trait. In another embodiment, the assessment may be provided in a non-electronic format (e.g., paper format for an offline assessment evaluation) or other formats; the rater may complete the assessment and the resulting evaluation may be inputted back into the performance assessment system 1001 electronically (e.g., optical scanning and character recognition, scantron input). Completed assessment evaluations are stored in the assessment response database 1022.

The assessment analysis module 1014 is configured to retrieve the set of the completed assessment evaluations in the assessment response database 1022 for analysis of the performance assessed. In an embodiment, the analysis may include aggregating the ratings from all raters for a trait/dimension (e.g., aggregate rating for the raters 629 as discussed above with respect to FIG. 6) or raters within a certain group (e.g., for ratings for the various constituency groups 710 as discussed above with respect to FIG. 7). The analysis may also include comparing the ratings for a trait/dimension among the constituency groups according to empirical relations analysis (e.g., chart 900 as discussed above with respect to FIGS. 9A-D). The analysis may further include aggregating the lowest rated trait/dimension within certain tiers of traits or some trait/dimension that is identified by the raters as in need of improvement (e.g., as represented into developmental recommendation 500 as discussed above with respect to FIG. 5). These aggregation may take the form of various statistical analysis (e.g., mean, median, mode) and other algorithmic, formulaic, or heuristic analysis.

In an embodiment, the analysis may also include controlling for various forms of bias (e.g., subjective bias of one or more raters) or other statistical anomalies of the evaluations. For example, subjective bias of a rater may be determined by comparing the score for a trait provided by the rater to scores provided by other raters (e.g., outlier analysis). The evaluation of the rater may be removed from the overall analysis if it is determined that the rater has subjective bias. In another embodiment, ratings for one or more traits given by certain identified raters that may be determined to be more reliable for evaluating those traits may be bias with certain weights. Certain traits may also be uniformly bias with certain weightings to account for these traits' importance to the performance assessed because of the individual's organization type, organization role, position/level within the organization, or other criteria. The analysis may also include other bias control methods as discussed above with respect to FIG. 6. The result of the analysis may be stored to the assessment analysis database 1023.

The report/recommendation generation module 1015 is configured to generate various reports and/or recommendations for improvements to the individual's performance based on the assessment analysis. In an embodiment, the result report may be based on a template presentation format (e.g., in chart form such as integrated quantitative summary 620 as discussed above with respect to FIG. 6, in descriptive report form such as descriptive summary 700 as discussed above with respect to FIG. 7, stand-alone recommendations such as developmental recommendation 500 as discussed above with respect to FIG. 5, an equity/disequity presentation of the qualitative diagnostic such as the assessment rating scheme 400 as discussed above with respect to FIG. 4, or a combination of these and other presentation formats).

In a further embodiment, the report/recommendation generation module 1015 may also select to include some of the qualitative diagnostic evaluations from the raters. Here, the qualitative evaluations may be selected based on the corresponding quantitative score (e.g., selecting a representative qualitative evaluation for each subgroup of raters, such as selecting a rater within a group of subordinates that rated the individual a ‘4’ for the trait when the subordinate group's aggregate score for the trait is a ‘4’). The qualitative evaluation may also be parse by a natural language processor or other artificial intelligence and be selected based on heuristic, algorithmic, or other artificial intelligence methods (e.g., neural network) or human-based computation (HBC).

The generated reports and recommendations are stored in the report database 1024 for retrieval by a relevant person (e.g., expert reviewer 1042 to review the reports and recommendations for consistency and other issues) or sent to the organization 1004 for reporting and structuring of an improvement program for the individual.

In an embodiment, the performance assessment system 1001 may work in conjunction with the ordering system 1002 and the reporting system 1003 for integrating an automated performance assessment and diagnostic system for an organization 1004.

It is noted that the automated performance assessment and diagnostic system may be used by various organizations, profit and nonprofit, small and large, as well as assessment for interested individual (e.g., political candidates, small business owners, independent contractors). It is further noted that uses for these assessment applications may include diagnostic development (e.g., for “fast-track” high-potential candidates), annual review (e.g., for measuring and tracking longitudinal progress), and promotion considerations. Data from assessments may also be used to establish norms for the assessed performance within the organization, functional unit, industry, or other levels of organizational structure.

In an embodiment, the management 1051 (e.g., HR) may access the ordering system 1002 through network 1099 (e.g., the Internet) for ordering an assessment for some performance of a subject 1052 (e.g., the individual). Through the ordering module 1031, an order form may be displayed for obtaining various information related to the subject 1052, such as the subject's position within the organization and background information (e.g., performance type to be assessed, the reason for assessment), and information related to one or more other raters (e.g., contact information (for coordinating assessment with each rater by the assessment module 1013) and their relationship with the subject (e.g., superordinate, peer, subordinate)). Other information that may be provided include dimensions/traits or other information of interest to the organization 1004 that are relevant to the assessment when the performance dimensions/traits are defined by the performance dimensions/traits definition module 1011. The provided information is stored in an order database to be processed by the performance assessment system 1001.

The order review module 1033 is configured to review the order to ensure consistency and other issues. In an embodiment, organization 1004 may be provided with a sample assessment of the ordered assessment as a pre-test to verify the ordered assessment. This sample assessment may be served to the organization 1004 after the performance dimensions/traits definition module 1011 and the assessment generation module 1012 has processed the assessment but prior to the actual assessment by the assessment module 1013.

Once the reports and/or recommendations have been generated by the report/recommendation generation module 1015, the reporting system 1003 may proceed with a review of the reports and/or recommendations through the review module 1041. In an embodiment, expert reviewer 1042 (e.g., an expert or trained professional in the relevant field) may review the reports and/or recommendations for integrity, consistency, and other issues. In another embodiment, the reporting system 1003 may further provide raw assessment data (e.g., raw ratings and qualitative responses data from each of the raters) for further analysis by the organization 1004 or a third party. The reports and/or recommendations are sent back to the organization 1004 or other designated parties.

In an embodiment, various information and data in the various stages of the assessment process (e.g., assessment configurations, assessment responses, assessment analyses, reports and recommendations) may be stored and used for future access (e.g., for longitudinal studies of the individual, comparisons of personals within a group or organization, performance traits definition and research).

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as a discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for assessing and tracking leadership skills of an individual of an organization, comprising performing following steps (a)-(e):
(a) the step of obtaining one or more evaluation data related to one or more ratings of the individual, each of the rating corresponding to a dimension of a predetermined set of dimensions defining key leadership traits or skills for the individual, wherein each evaluation data is obtained from a relevant constituency of the organization, and wherein one of the evaluation data is obtained from the individual;
(b) the step of obtaining a response from the relevant constituency or the individual, the response includes, for the each of the corresponding evaluation data, each of (i) and (ii):
(i) a first reason for the rating not being one step more positive, when the rating is not a highest available rating; and
(ii) a second reason for the rating not being one step more negative, when the rating is not a lowest available rating;
(c) the step of storing the evaluation data, including the response;
(d) the step of evaluating a first portion of a summary of the evaluation data, including the response, of all of the relevant constituencies and the individual, across the predetermined set of dimensions, wherein the first portion includes an aggregate rating of the individual for the each of the corresponding dimension and a comparison of the aggregate rating with the rating obtained from the individual for the each of the corresponding dimension; and
(e) the step of evaluating a second portion of the summary, wherein the second portion includes an identification of one or more areas of growth potentials corresponding to one or more selected grouped dimensions of the predetermined set of dimensions, wherein the identification of the areas of the growth potentials includes a summary of each dimension with respect to either (i) a lowest rating in each of the selected grouped dimensions or (ii) identified by the relevant constituency or the individual, for each of the relevant constituency and the individual.

2. The method of claim 1, wherein the predetermined dimensions of leadership traits or skills comprises one or more of a personal integrity dimension, a personal responsibility dimension, a professional expertise dimension, a problem-solving orientation dimension, a goal driven dimension, a hold others accountable dimension, a builds relationships dimension, a collaborative orientation dimension, a self development dimension, a motivation energizer dimension, a develops others dimension, an innovative dimension, and a strategic vision dimension.

3. The method of claim 2, wherein the one or more selected grouped dimensions comprises a leadership skills group comprising the self development, the motivation energizer dimension, the develops others dimension, and the innovative dimension.

4. The method of claim 2, wherein the one or more selected grouped dimensions comprises a core traits group comprising the personal integrity dimension, the personal responsibility dimension, the professional expertise dimension, the problem solving orientation dimension, the goal driven dimension, the hold others accountable dimension, the builds relationships dimension, and the collaborative orientation dimension.

5. The method of claim 2, wherein the one or more selected grouped dimensions comprises one or more of a character group comprising the personal integrity dimension and the personal responsibility dimension, a professional skills group comprising the professional expertise dimension and the problem solving orientation dimension, a focus on results group comprising the goal driven dimension and the hold others accountable dimension, and an interpersonal skills group comprising the builds relationships dimension, and the collaborative orientation dimension.

6. The method of claim 1, further comprising (f) a step of preparing an assessment report for the individual based on the evaluation data, the assessment report including a summary of the aggregate rating for the each of the corresponding dimensions, the comparison of the aggregate rating with the rating obtained from the individual for the each of the corresponding dimension, a comparison of the rating obtained from one or more groups of the relevant constituency with each other and with the individual, a summary of comments for the each of the corresponding dimension, and one or more recommendation priorities corresponding to one or more of the dimensions.

7. The method of claim 1, wherein the step of (a) comprises, presenting, on a display, a request to the relevant constituency or the individual to input the one or more ratings and one or more comments, each of the comments related to the each of the ratings.

8. The method of claim 1, wherein the relevant constituency is selected from a group of superiors, peers, or subordinates of the individual.

9. A method for assessing and tracking leadership skills of an individual of an organization, comprising performing following steps (a)-(e):
(a) the step of obtaining, by computational equipment, one or more evaluation data related to one or more ratings of the individual, each rating corresponding to a dimension of a predetermined set of dimensions of leadership traits or skills for the individual, wherein each evaluation data is obtained from a relevant constituency of the organization, wherein one of the evaluation data is obtained from the individual, and wherein the step of (a) comprises (a-i) and (a-ii):
(a-i) the step of displaying, through the computational equipment, to the relevant constituency or the individual a survey containing a series of question related to the predetermined set of dimensions; and
(a-ii) the step of receiving, through the computational equipment, from the relevant constituency or the individual a response to the survey that includes the rating, wherein the rating comprises a numerical assessment of the individual, for a dimension of the predetermined set of dimensions, based a scale;
(b) the step of receiving, through the computational equipment, a response from the relevant constituency or the individual, the response includes, for the each of the corresponding evaluation data, each of (i) and (ii):
(i) a first reason for the rating not being one step more positive, when the rating is not a highest available rating; and
(ii) a second reason for the rating not being one step more negative, when the rating is not a lowest available rating;
(c) the step of storing, using the computational equipment, the evaluation data, including the response;
(d) the step of evaluating, using the computational equipment, a first portion of a summary of the evaluation data, including the response, of all of the relevant constituencies and the individual, across the predetermined set of dimensions, wherein the first portion includes an aggregate rating of the individual for the each of the corresponding dimension and a comparison of the aggregate rating with the rating obtained from the individual for the each of the corresponding dimension; and
(e) the step of evaluating, using the computational equipment a second portion of the summary, wherein the second portion includes an identification of one or more areas of growth potentials corresponding to one or more selected grouped dimensions of the predetermined set of dimensions, wherein the identification of the areas of the growth potentials includes a summary of each dimension with respect to either (i) a lowest rating in each of the selected grouped dimensions or (ii) identified by the relevant constituency or the individual, for each of the relevant constituency and the individual.

10. The method of claim 9, wherein the predetermined set of dimensions of leadership traits or skills comprises one or more of a personal integrity dimension, a personal responsibility dimension, a professional expertise dimension, a problem solving orientation dimension, a goal driven dimension, a hold others accountable dimension, a builds relationships dimension, a collaborative orientation dimension, a self development dimension, a motivation energizer dimension, a develops others dimension, an innovative dimension, and a strategic vision dimension.

11. The method of claim 10, wherein the one or more selected grouped dimensions comprises a leadership skills group comprising the self development, the motivation energizer dimension, the develops others dimension, and the innovative dimension.

12. The method of claim 10, wherein the one or more selected grouped dimensions comprises a core traits group comprising the personal integrity dimension, the personal responsibility dimension, the professional expertise dimension, the problem solving orientation dimension, the goal driven dimension, the hold others accountable dimension, the builds relationships dimension, and the collaborative orientation dimension.

13. The method of claim 10, wherein the one or more selected grouped dimensions comprises one or more of a character group comprising the personal integrity dimension and the personal responsibility dimension, a professional skills group comprising the professional expertise dimension and the problem solving orientation dimension, a focus on results group comprising the goal driven dimension and the hold others accountable dimension, and an interpersonal skills group comprising the builds relationships dimension, and the collaborative orientation dimension.

14. The method of claim 9, further comprising (f) a step of preparing an assessment report for the individual based on the evaluation data, the assessment report including a summary of the aggregate rating for the each of the corresponding dimension, the comparison of the aggregate rating with the rating obtained from the individual for the each of the corresponding dimension, a comparison of the rating obtained from one or more groups of the relevant constituency with each other and with the individual, a summary of comments for the each of the corresponding dimension, and one or more recommendation priorities corresponding to one or more of the dimensions.

15. The method of claim 9, wherein the step of (a) comprises, presenting, on a display, a request to the relevant constituency or the individual to input the one or more ratings and one or more comments, each of the comments related to the each of the ratings.

16. The method of claim 9, wherein the relevant constituency is selected from a group of superiors, peers, or subordinates of the individual.

17. A method for assessing and tracking leadership skills of an individual of an organization, comprising performing following steps (a)-(e):
(a) the step of receiving an initial order for an assessment or tracking of the leadership skills of the individual;
(b) the step of obtaining one or more evaluation data related to one or more ratings of the individual, each rating corresponding to a dimension of a predetermined set of dimensions of leadership traits or skills for the individual, wherein each evaluation data is obtained from a relevant constituency of the organization, and wherein one of the evaluation data is obtained from the individual;
(c) the step of obtaining a response from the relevant constituency or the individual, the response includes, for the each of the corresponding evaluation data, each of (i) and (ii):
(i) a first reason for the rating not being one step more positive, when the rating is not a highest available rating; and
(ii) a second reason for the rating not being one step more negative, when the rating is not a lowest available rating;
(d) the step of storing the evaluation data, including the response;
(e) the step of evaluating a first portion of a summary of the evaluation data, including the response, of all of the relevant constituencies and the individual, across the predetermined set of dimensions, wherein the first portion includes an aggregate rating of the individual for the each of the corresponding dimension and a comparison of the aggregate rating with the rating obtained from the individual for the each of the corresponding dimension;
(f) the step of evaluating a second portion of the summary, wherein the second portion includes an identification of one or more areas of growth potentials corresponding to one or more selected grouped dimensions of the predetermined set of dimensions, wherein the identification of the areas of the growth potentials includes a summary of each dimension with respect to either (i) a lowest rating in each of the selected grouped dimensions or (ii) identified by the relevant constituency or the individual, for each of the relevant constituency and the individual; and
(g) the step of preparing an assessment report for the individual based on the evaluation data, the assessment report including a summary of the average rating for the each of the corresponding dimension, the comparison of the aggregate rating with the rating obtained from the individual for the each of the corresponding dimension, a comparison of the rating obtained from one or more groups of the relevant constituency with each other and with the individual, a summary of comments for the each of the corresponding dimension, and one or more recommendation priorities corresponding to one or more of the dimensions.

18. The method of claim 17, wherein the predetermined dimensions of leadership traits or skills comprises one or more of a personal integrity dimension, a personal responsibility dimension, a professional expertise dimension, a problem solving orientation dimension, a goal driven dimension, a hold others accountable dimension, a builds relationships dimension, a collaborative orientation dimension, a self development dimension, a motivation energizer dimension, a develops others dimension, an innovative dimension, and a strategic vision dimension, wherein the one or more selected grouped dimensions comprises a leadership skills group comprising the self development, the motivation energizer dimension, the develops others dimension, and the innovative dimension, and wherein the one or more selected grouped dimensions comprises a core traits group comprising the personal integrity dimension, the personal responsibility dimension, the professional expertise dimension, the problem solving orientation dimension, the goal driven dimension, the hold others accountable dimension, the builds relationships dimension, and the collaborative orientation dimension.

19. The method of claim 17, further comprising a step of evaluating a bias of the evaluation data and removing the bias prior to the evaluating of the summary.

20. A method for assessing and tracking performance of an individual of an organization, comprising performing following steps (a)-(f):
(a) the step of determining a set of dimensions defining key traits and skills related to the performance being assessed and tracked;
(b) the step of obtaining one or more evaluation data related to one or more ratings of the individual, each of the rating corresponding to a dimension of the set of dimensions for the individual, wherein each evaluation data is obtained from a relevant constituency of the organization, and wherein one of the evaluation data is obtained from the individual;
(c) the step of obtaining a response from the relevant constituency or the individual, the response includes, for the each of the corresponding evaluation data, each of (i) and (ii):
(i) a first reason for the rating not being one step more positive, when the rating is not a highest available rating; and
(ii) a second reason for the rating not being one step more negative, when the rating is not a lowest available rating;
(d) the step of storing the evaluation data, including the response;
(e) the step of evaluating a first portion of a summary of the evaluation data, including the response, of all of the relevant constituencies and the individual, across the set of dimensions, wherein the first portion includes an aggregate rating of the individual for the each of the corresponding dimension and a comparison of the aggregate rating with the rating obtained from the individual for the each of the corresponding dimension; and
(f) the step of evaluating a second portion of the summary, wherein the second portion includes an identification of one or more areas of growth potentials corresponding to one or more selected grouped dimensions of the set of dimensions, wherein the identification of the areas of the growth potentials includes a summary of each dimension with respect to either (i) a lowest rating in each of the selected grouped dimensions or (ii) identified by the relevant constituency or the individual, for each of the relevant constituency and the individual.

21. The method of claim 1, further comprising a step of (d−1) evaluating a third portion of the summary, wherein the third portion includes a group aggregate rating of the individual for the each of the corresponding dimensions and a comparison of the group aggregate rating with a second group aggregate rating for the each of the corresponding dimension, wherein the group aggregate rating is determined from the rating obtained from a subset of all of the relevant constituencies, and wherein the second group aggregate rating is determined from the rating obtained from a second subset of all of the relevant constituencies.

22. The method of claim 21, wherein the third portion includes a comparison among the group aggregate rating, the second group aggregate rating, one or more other group aggregate rating, and the rating obtained from the individual, wherein each of the other group aggregate rating is determined from the rating obtained from a corresponding subset of all of the relevant constituencies, wherein the subset, the second subset, and the each corresponding subset includes all of the constituencies, and wherein the subset, the second subset, and the each corresponding subset are disjoint.
